(19) United States
(12) Patent Application Publication
(10) Pub. No.: US 2018/0009472 A1
(43) Pub. Date: Jan. 11, 2018

(54) STEERING HOLDING JUDGING APPARATUS FOR VEHICLE AND ELECTRIC POWER STEERING APPARATUS EQUIPPED WITH THE SAME

(71) Applicant: NSK LTD., Tokyo (JP)

(72) Inventors: Hideki SAWADA, Tokyo (JP); Takayoshi SUGAWARA, Tokyo (JP); Ryo MINAKI, Tokyo (JP)

(73) Assignee: NSK LTD., Tokyo (JP)

(21) Appl. No.: 15/545,539

(22) PCT Filed: Feb. 2, 2016
(86) PCT No.: PCT/JP2016/053005

§ 371 Date: Jul. 21, 2017

(30) Foreign Application Priority Data
Feb. 2, 2015 (JP) 2015-018527
Feb. 16, 2015 (JP) 2015-028002
Feb. 17, 2015 (JP) 2015-028324

(51) Int. Cl. B62D 6/00; B62D 5/04; B62D 15/02

(52) U.S. Cl. CPC B62D 6/002; B62D 15/0215; B62D 5/0463; B62D 5/0409

(57) ABSTRACT

A steering holding judging apparatus for the vehicle including: at least two steering angle sensors to detect a steering angle; and a steering state judging section to calculate a hysteresis central value by using a hysteresis signal that sets a hysteresis width to the two steering angle sensor, judge a steering state using the hysteresis central value, and output provisional steering information, wherein a steering holding state is detected based on the provisional steering information, and the electric power steering apparatus equipped with the steering holding judging apparatus for the vehicle.

### TECHNICAL FIELD

The present invention relates to a steering holding judging apparatus for a vehicle that accurately and immediately judges a steering holding state of a steering system of a vehicle and appropriately performs a current limiting of the motor, and an electric power steering apparatus that is equipped with the above steering holding judging apparatus for the vehicle and provides the steering system of the vehicle with a steering assist force by means of a motor, and in particular to the steering holding judging apparatus for the vehicle that limits a current command value of the motor to the current which can maintain the steering holding state in a state of transiting from a steer-forward to the steering holding state, or detects a transition faster than a detection of entering the steering holding state, releases the current limiting and passes the suitable current when transiting from the steering holding state to the steer-forward, and the electric power steering apparatus equipped with the above steering holding judging apparatus for the vehicle.

### BACKGROUND ART

An electric power steering apparatus (EPS) which assist-controls a steering system of a vehicle by means of a rotational torque of a motor, applies the steering assist torque to a steering shaft or a rack shaft by means of a transmission mechanism such as gears or a belt through a reduction mechanism. In order to accurately generate the assist control torque (steering assist torque), such a conventional electric power steering apparatus performs a feedback control of a motor current. The feedback control adjusts a voltage supplied to the motor so that a difference between a steering assist command value (a current command value) and a detected motor current value becomes small, and the adjustment of the voltage applied to the motor is generally performed by an adjustment of a duty of a pulse width modulation (PWM) control.

A general configuration of the conventional electric power steering apparatus will be described with reference to FIG. 1. As shown in FIG. 1, a column shaft (a steering shaft or a handle shaft) 2 connected to a steering wheel 1 is connected to steered wheels 8L and 8R through reduction gears 3, universal joints 4a and 4b, a rack-and-pinion mechanism 5, and tie rods 6a and 6b, further via hub units 7a and 7b. The column shaft 2 is provided with a torque sensor 10 for detecting a steering torque Th of the steering wheel 1 as a torsional torque of a torsion bar and a steering angle sensor 14 for detecting a steering angle θ, and a motor 20 for assisting a steering force of the steering wheel 1 is connected to the column shaft 2 through the reduction gears 3. The electric power is supplied to a control unit (ECU) 30 for controlling the electric power steering apparatus from a battery 13, and an ignition key signal is inputted into the control unit 30 through an ignition key 11. The control unit 30 calculates a current command value, which is an assist command, on the basis of a steering torque Th detected by the torque sensor 10 and a vehicle speed Vel detected by a vehicle speed sensor 12, and controls a current supplied to the motor 20 by means of a voltage control value Vref obtained by performing compensation or the like to the calculated current command value.

The controller area network (CAN) 40 to send/receive various information and signals on the vehicle is connected to the control unit 30, and it is also possible to receive the vehicle speed Vel from the CAN. Further, a Non-CAN 41 is also possible to connect to the control unit 30, and the Non-CAN 41 sends and receives a communication, analogue/digital signals, electric wave or the like except for the CAN 40.

In such an electric power steering apparatus, the control unit 30 mainly comprises a CPU (Central Processing Unit) (including an MPU (Micro Processor Unit) and an MCU (Micro Controller Unit)), and general functions performed by programs within the CPU are, for example, shown in FIG. 2.

The control unit 30 will be described with reference to FIG. 2. The steering torque Th detected from the torque sensor 10 and the vehicle speed Vel detected from the vehicle speed sensor 12 are inputted into a current command value calculating section 31 which calculates a current command value Iref1, based on the steering torque Th and the vehicle speed Vel using an assist map or the like. The calculated current command value Iref1 is added with a compensation signal CM for improving characteristics from a compensating section 34 at an adding section 32A. The added current command value Iref2 is limited of the maximum value thereof at a current limiting section 33. The current command value Irefm limited of the maximum value is inputted into a subtracting section 32B, whereat a detected motor current value Im is subtracted from the current command value Irefm.

A deviation, which is the subtraction result at the subtracting section 32B, ΔI=(Irefm−Im) is proportional and integral (PI)-controlled at a PI-control section 35. The PI-controlled voltage control value Vref is inputted into a PWM-control section 36, whereat a duty thereof is calculated in synchronization with a carrier signal CF. The motor 20 is PWM-driven by an inverter 37 with a PWM signal. The motor current value Im of the motor 20 is detected by a motor current detector 38 and is inputted into the subtracting section 32B for the feedback.

The compensating section 34 adds a self-aligning torque (SAT) 343 detected or estimated and an inertia compensation value at an adding section 344. The addition result is further added with a convergence control value 341 at an adding section 345. The addition result is inputted into the adding section 32A as the compensation signal CM, thereby to improve the characteristics of the current command value.

In such an electric power steering apparatus, since the current that is required to maintain the steering holding state, considering a friction of the column shaft, has a hysteresis characteristic in a transition from the steer-forward to the steering holding state, which no steering has been done (variations of the motor rotational number and the steering assist torque is almost zero, and the motor rotational number is almost zero), it is preferred that the current limiting of the motor should be performed. In the steering holding state, since the large assist torque is not required in normal, it is necessary to surely avoid an unnecessary power consumption and a heat generation.

FIG. 3 shows a general characteristic example of a steering angle and a current. In steer-forward and steer-backward of the handle, the hysteresis in the current is existed due to the friction in the same steering angle. In a case of no friction, as shown in FIG. 3, the current against the steering angle varies linearly.

In a handle end hitting steering state (a rack end state) and the steering holding state, even though a driver does not steer-forward consciously, there is a possibility that a unnecessary steering assist torque is largely generated (an excessive motor current is passed). Then, it is requested that such a state is surely avoided.

As the electric power steering apparatus that decreases the steering holding force of the driver in order to suppress a drift of the vehicle, Japanese Patent No.4815958 B2 (Patent Document 1) is proposed. In Patent Document 1, in order to detect the steering holding state, a steering angle sensor, the vehicle speed sensor, a yaw rate sensor, the torque sensor and the motor rotational angle sensor are used. As the electric power steering apparatus that performs the current limiting of an assist motor in the steering holding state, Japanese Patent No.3915964 B2 (Patent Document 2) is proposed. Estimating values and the like that are calculated by various calculations using a motor voltage detecting value, a motor current detecting value, the torque sensor and the motor rotational angle sensor, are used for detecting the steering holding state by being extremely small values of a torque variation amount and a rotational number variation amount, and a considerable amount of the steering torque.

### THE LIST OF PRIOR ART DOCUMENTS

### Patent Documents

Patent Document 1: Japanese Patent No.4815958 B2

Patent Document 2: Japanese Patent No.3915964 B2

### SUMMARY OF THE INVENTION

### Problems to be Solved by the Invention

Using the motor rotational angle sensor as Patent Documents 1 and 2, since the rotational number signal of the motor or the like includes a noise, a low pass filter (LPF) has to be used to decrease an influence of the noise, and then a delay for processing this process is occurred. It is necessary to set a certain threshold (the threshold is set larger than a noise) in order that a state which the motor rotational number is zero, which indicates the steering holding (motor is stopped), is judged. There are problems that the apparatus erroneously judges the steering holding when steering, the apparatus cannot judge the steering holding in the steering holding and the apparatus requires a time in judging the steering holding by being a cause of this threshold.

In the judgment of the steering torque, the steering holding state is judged by an amount (an absolute value) and a changing rate of the steering torque or the like. However, when judging the amount of the steering torque, there are problems that the apparatus can only detect the steering holding state in particular conditions (for example, hitting to the rack end or the like), and in a case that the changing rate of the steering torque, the apparatus erroneously judges the steering holding in gradually changing the steering torque since the judgement is performed by the changing rate against the time.

Further, in the electric power steering apparatus, considering the friction around the column shaft under a state that the motor generates a large torque and stops or almost stops just after transiting from a steer-forward to the steering holding state, there are problems of unnecessary power consumption and heat generation and the like because an excessive current is supplied to the motor in order to maintain the steering holding state.

Furthermore, when transiting from the steering holding state to the steer-forward, it is necessary to detect the transition faster than the detection of entering the steering holding state, release the current limiting, pass the suitable current and easily transit from the steering holding state (a hysteresis width is small).

The present invention has been developed in view of the above-described circumstances, and an object of the present invention is to provide the steering holding judging apparatus for the vehicle that surely judges the steer-forward, the steer-backward and the steering holding state, limits the current which can maintain the steering holding state utilizing the friction of the column shaft when transiting from the steer-forward to the steering holding state, or detects the transition faster than the detection of entering the steering holding state, releases the current limiting, passes the suitable current and easily transits from the steering holding state when transiting from the steering holding state to the steer-forward, and the electric power steering apparatus equipped with the above steering holding judging apparatus for the vehicle.

Further, another object of the present invention is to provide the steering holding judging apparatus for the vehicle that detects or does not erroneously judge the steering holding state under various circumstances which do not occur in unnecessary power consumption and heat generation and the like, can accurately and immediately detect the steering holding state even though the noise is superimposed to the signal which uses to the detection, and can appropriately perform the current limiting of the motor, and the electric power steering apparatus equipped with the steering holding judging apparatus for the vehicle.

### Means for Solving the Problems

The present invention relates to the steering holding judging apparatus, the above-described object of the present invention is achieved by that comprising: at least two steering angle sensors to detect a steering angle of a steering system of a vehicle; and a steering state judging section to calculate a hysteresis central value using a hysteresis signal that sets a hysteresis width to steering signals from the two steering angle sensor, judge a steering state using the hysteresis central value, and output provisional steering information, wherein a steering holding state is detected based on the provisional steering information,

or comprising: a control unit to control a motor, which is coupled to a steering system of a vehicle, by means of a driving current; a steering angle detecting means to detect a column input-side angle and a column output-side angle of the steering system, and output a column input-side angle signal and a column output-side angle signal; a steering state judging section to output steering information and a steering holding signal of the steering system based on the column input-side angle signal and the column output-side angle signal; and a current limiting section to limit the driving current based on the steering information and the steering holding signal, wherein the steering state judging section comprises a hysteresis width setting section to calculate and set hysteresis widths “A” and “B” (<“A”) to the column input-side angle signal and the column output-side angle signal, respectively; a hysteresis central value calculating section to calculate respective hysteresis central values of the hysteresis widths “A” and “B”; a hysteresis filter judging section to turn-ON or turn-OFF a hysteresis trigger signal based on the hysteresis central value of the hysteresis width “A”; and a switching judging section to output the steering information and the steering holding section based on the hysteresis central value of the hysteresis width “A” when the hysteresis signal is OFF, and the hysteresis central values of the hysteresis widths “A” and “B” when the hysteresis signal is ON.

The present invention relates to the electric power steering apparatus that calculates a torque control output current command value based on at least the steering torque, and assist-controls the steering system by driving the motor based on the torque control output current command value, the above-described object of the present invention is achieved by that comprising: the steering holding judging apparatus for the vehicle, or comprising: an angle detecting means to output a column input-side angle signal and a column output-side angle signal of the steering system; a steering state judging section to judge a steering state based on the column input-side angle signal and the column output-side angle signal, and output a steering holding signal and steering information; and a current limiting section to limit the torque control output current command value based on the column input-side angle signal, the column output-side angle signal, the steering holding signal and the steering information, wherein the current limiting section performs a current limiting of the torque control output current command value in a range of a current which a steering holding state is maintained.

### Effects of the Invention

According to the electric power steering apparatus of the present invention, the unnecessary power consumption and the heat generation and so on are not occurred since the current command value is limited (gradually changed) in a range of the current which the steering holding state is maintained, considering the friction of the column shaft, when detecting the transition from the steer-forward to the steering holding state.

According to the steering holding judging apparatus for the vehicle of the present invention, the unnecessary power consumption and the heat generation and so on are not occurred since the current command value is limited (gradually changed) in a range of the current which the steering holding state is maintained, considering the friction of the column shaft, when detecting the transition from the steer-forward to the steering holding state. Because at least two detected steering angles (steering angle signals) are applied the hysteresis characteristic, and the steering holding state is detected by using the steering angle signals which are applied the hysteresis characteristic, an immediate detecting is possible without a filter process and the like even if a noise and the like is occurred, and it is possible to perform an accurate detecting in accordance with a steering state.

Further, when transiting from the steering holding state to the steer-forward, the apparatus detects the transition faster than the detection of entering the steering holding state, releases the current limiting, passes the suitable current and easily transits from the steering holding state (the hysteresis width is small).

### BRIEF DESCRIPTION OF THE DRAWINGS

In the accompanying drawings:

FIG. 1 is a configuration diagram illustrating a general outline of an electric power steering apparatus;

FIG. 2 is a block diagram showing a general configuration example of a control system of the electric power steering apparatus;

FIG. 3 is a characteristic diagram illustrating a general relationship between a steering angle and a current;

FIG. 4 is a timing chart showing a transition operating example of a steering of the present invention;

FIG. 5 is a flowchart showing a principle of an operating example of the present invention;

FIG. 6 is a block diagram showing a configuration example (the first embodiment) of the present invention;

FIG. 7 is a block diagram showing a configuration example of a steering holding state judging section;

FIG. 8 is a block diagram showing a configuration example of a current limiting section;

FIG. 9 is a diagram showing a mounting example of sensors and a relationship of column angle signals which are used in the present invention;

FIG. 10 is a flowchart showing an operating example of a steering state judging section (judging a steering holding) according to the present invention;

FIG. 11 is a flowchart showing an operating example of the steering state judging section (judging a steering) according to the present invention;

FIG. 12 is a flowchart showing an operating example of the present invention;

FIG. 13A and FIG. 13B are a waveform diagram of a steering angle and a waveform diagram of a current for describing the current limiting of the present invention, respectively;

FIG. 14A and FIG. 14B are diagrams showing judging examples of a handle steer-forward and a handle steer-backward according to the present invention, respectively;

FIG. 15 is a schematic diagram for describing the current limiting of the present invention;

FIG. 16 is a timing chart showing an operating principle of the present invention;

FIG. 17 is a block diagram showing a configuration example (the second embodiment) of the present invention;

FIG. 18 is a block diagram showing a configuration example of a steering holding state judging section;

FIG. 19 is a block diagram showing a configuration example of a hysteresis filter “A”;

FIG. 20 is a block diagram showing a configuration example of a hysteresis filter “B”;

FIG. 21 is a flowchart showing an operating example of a steering state judging according to the present invention;

FIG. 22 is a flowchart showing an operating example of a hysteresis filter judging section of the present invention;

FIG. 23 is a block diagram showing a configuration example (the third embodiment) of the present invention;

FIG. 24 is a portion of a flowchart showing an operating example of the present invention;

FIG. 25 is another portion of a flowchart showing an operating example of the present invention;

FIG. 26 is a diagram showing an example of changing an actual steering angle and the like in the present invention and a prior art (in a case of generating a noise in a steering holding); and

FIG. 27 is a diagram showing an example of changing an actual steering angle and the like in the present invention and a prior art (in a case of slowly steering).

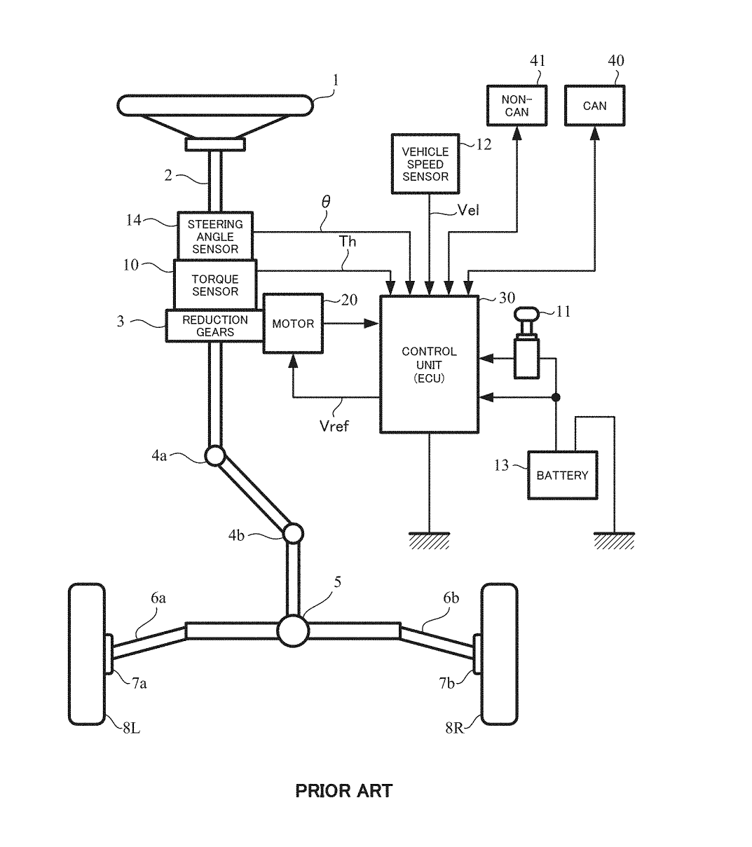

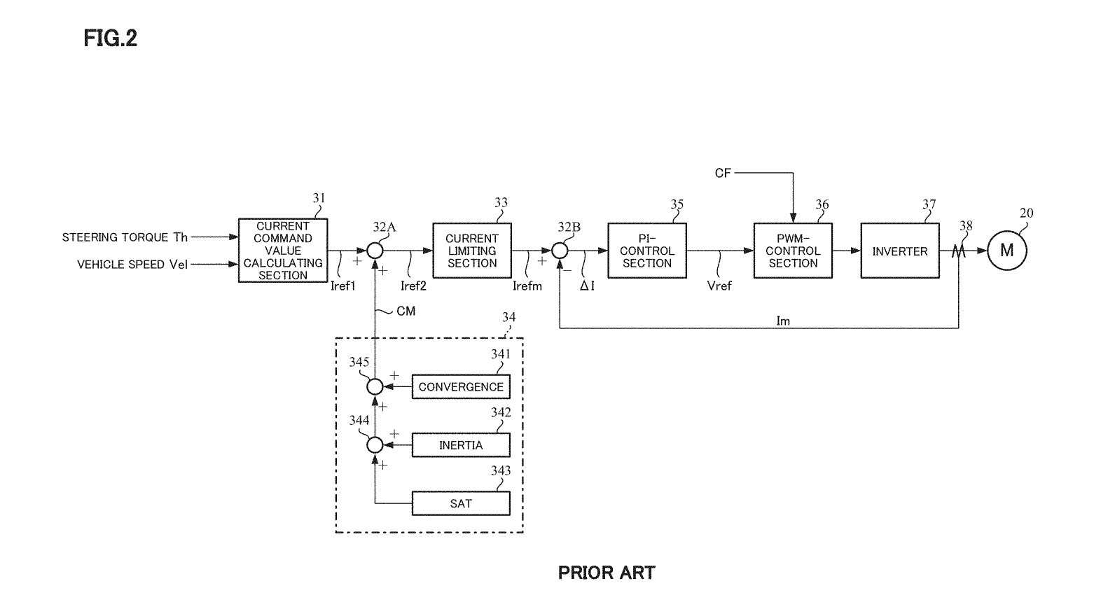

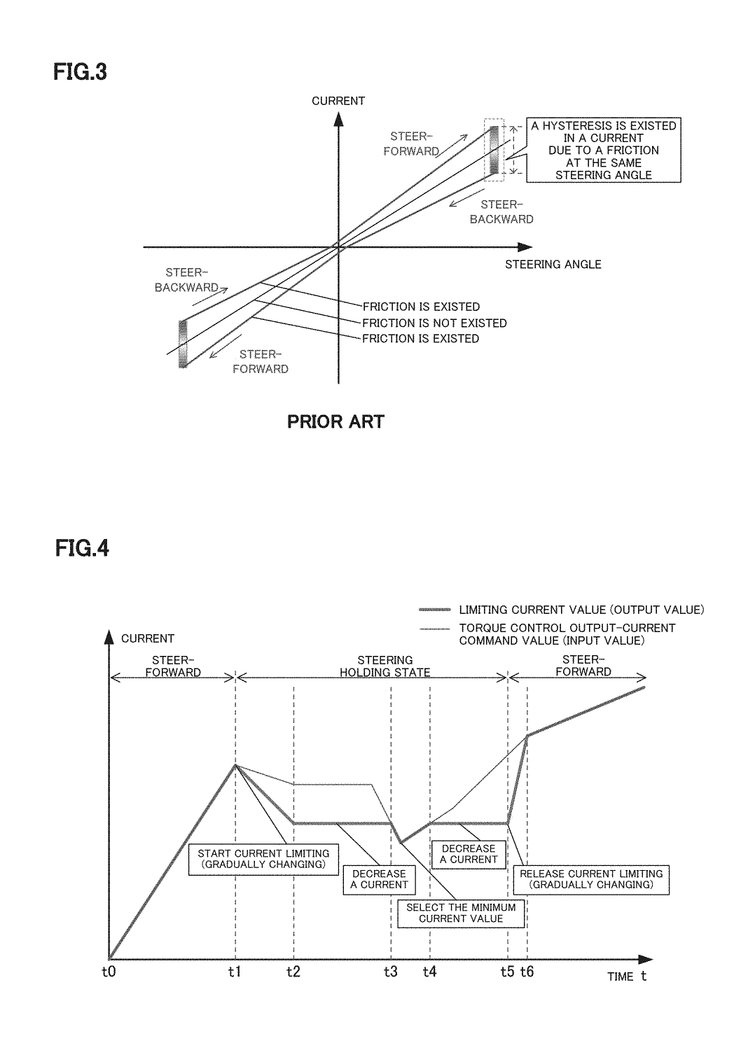

### MODE FOR CARRYING OUT THE INVENTION

An electric power steering apparatus of the present invention detects a transition from a steer-forward of a handle to a steering holding state, and in the steering holding state, limits (gradually changes) a current command value in a range of a current that can maintain the steering holding state, considering a friction of a column shaft.

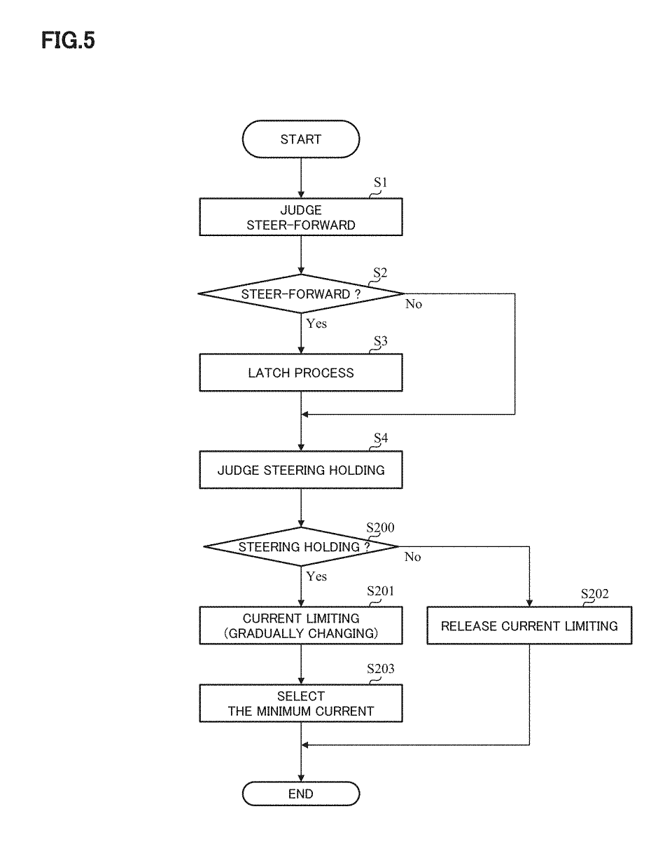

FIG. 4 shows a transition operating example of a steering. Changing examples of a torque control output current command value (an input value) and a limiting current value (an output value) are showed in the steer-forward (a time point t0 to a time point t1), the steering holding state (the time point t1 to a time point t5) and the steer-forward (a time after the time point t5). A flowchart of FIG. 5 shows the operating example.

The apparatus performs a judging of the steer-forward at the time point t1 (Step S1). In a case of the steer-forward (Step S2), the maximum value of the current command value is latched (Step S3). In a case of not the steer-forward in the Step S2, the process proceeds to a steering holding judging (Step S4).

As a result of the steering holding judging, in a case of the steering holding (Step S200), the current is limited (gradually changed) in a range of a current that can maintain the steering holding state (Step S201, the time point t1 to the time point t2). In the steering holding, by comparing the limiting current value to a target current (a target torque command≃a torque control output current command value), and selecting the smaller current value (minimum current) at the time point t3 (Step S203), the current command value enables to be limited to the current that can maintain the steering holding state (the time point t3 to the time point t4). When the steer-forward is started at the time point t5 (Step S200), the current limiting is immediately released (Step S202) and the process of the current limiting is ended.

As well, in FIG. 4, in the steer-forward from the time point t0 to the time point t1, the steering holding state (current minimum value is selected) from the time point t3 to the time point t4 and the steer-forward after the time point t6, the torque control output current command value is the same as the limiting current value.

In the present invention, when detecting the transition from the steer-forward of the handle to the steering holding state, since the current command value is limited (gradually changed) in a range of the current that can maintain the steering holding state, the unnecessary power consumption and the heat generation or the like are not occurred.

Embodiments according to the present invention will be described with reference to the drawings.

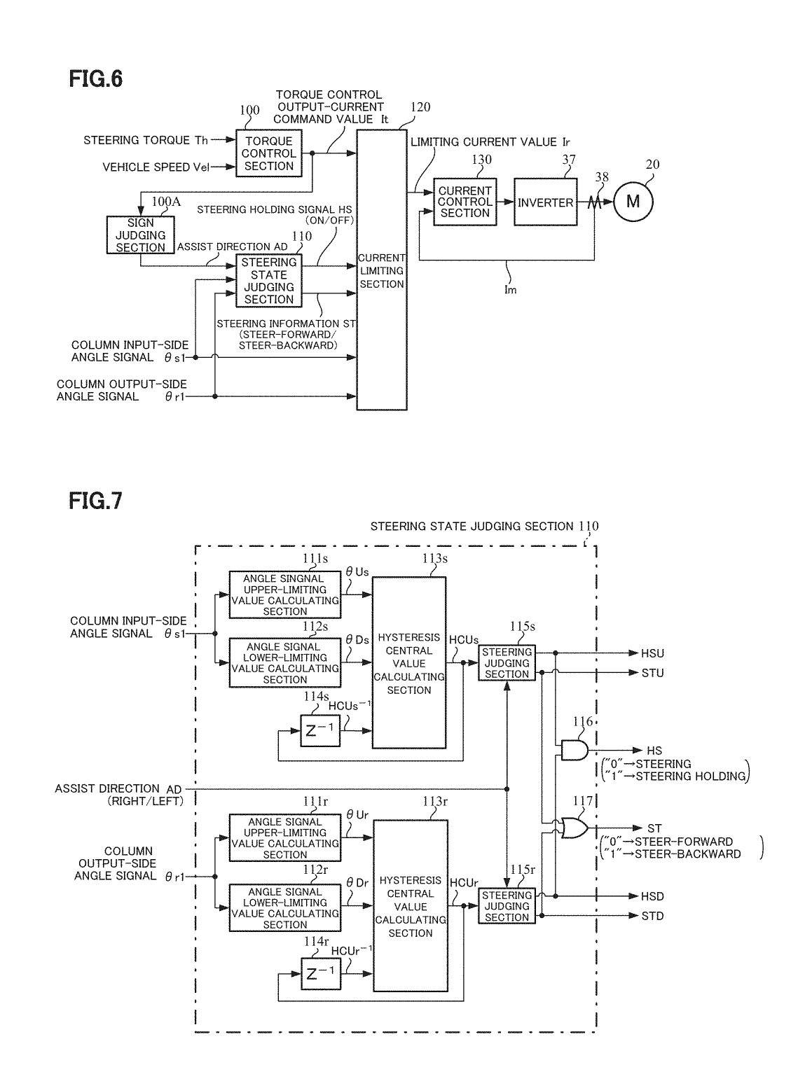

FIG. 6 shows a block diagram of a first embodiment of the present invention. A steering torque Th and a vehicle speed Vel are inputted into a torque control section 100, and the torque control output current command value “It” that is calculated based on the steering torque Th and the vehicle speed Vel is inputted into a sign judging section 100A, which judges a sign (a direction) of the command value, and a current limiting section 120. A column input-side angle signal θs1 and a column output-side angle signal θr1 from angle sensors which are provided with a column shaft are inputted into a steering state judging section 110. An assist direction AD from the sign judging section 100A is also inputted into the steering state judging section 110. A steering holding signal HS (ON (“1”)/OFF (“0”)) which is judged at the steering state judging section 110 and steering information ST (steer-forward (“0”)/steer-backward (“1”)) are inputted into the current limiting section 120. A limiting current value Ir from the current limiting section 120 and a motor current value Im are inputted into a current control section 130, and driving-control a motor 20 via an inverter 37. The current control section 130 comprises a proportional and integral (PI)-control section and a pulse width modulation (PWM)-control section.

The column input-side angle signal θs1 of the handle side and the column output-side angle signal θr1 of an intermediate shaft side are inputted into the steering state judging section 110, and hysteresis processes are performed to the column input-side angle signal θs1 and the column output-side angle signal θr1 by a configuration as shown in FIG. 7.

At first, the column input-side angle signal θs1 is described with reference to FIG. 7. The column input-side angle signal θs1 is inputted into an angle signal upper-limiting value calculating section 111s and an angle signal lower-limiting value calculating section 112s. The angle signal upper-limiting value calculating section 111s and the angle signal lower-limiting value calculating section 112s calculate an angle signal upper-limiting value θUs and an angle signal lower-limiting value θDs, respectively. The angle signal upper-limiting value θUs and the angle signal lower-limiting value θDs are inputted into a hysteresis central value calculating section 113s. A hysteresis central value HCUs, which is calculated at the hysteresis central value section 113s based on the angle signal upper-limiting value θUs and the angle signal lower-limiting value θDs, is inputted into a steering judging section 115s and is latched at a latch section (Z⁻¹) 114s. A past value HCUs⁻¹ which is latched is inputted into the hysteresis central value section 113s. The steering judging section 115s outputs a steering holding signal HSU when judging the steering holding based on changing of the assist direction and the hysteresis central value HCUs, and outputs steering information STU when judging the steer-forward or the steer-backward.

The steering holding signal HSU is inputted into a logical product (AND) circuit 116, and the steering information STU is inputted into a logical sum (OR) circuit 117.

Next, the column output-side angle signal θr1 is described with reference to FIG. 7. The column output-side angle signal θr1 is inputted into an angle signal upper-limiting value calculating section 111r and an angle signal lower-limiting value calculating section 112r. The angle signal upper-limiting value calculating section 111r and the angle signal lower-limiting value calculating section 112r calculate an angle signal upper-limiting value θUr and an angle signal lower-limiting value θDr, respectively. The angle signal upper-limiting value θUr and the angle signal lower-limiting value θDr are inputted into a hysteresis central value calculating section 113r. A hysteresis central value HCUr, which is calculated at the hysteresis central value section 113r based on the angle signal upper-limiting value θUr and the angle signal lower-limiting value θDr, is inputted into a steering judging section 115r and is latched at a latch section (Z⁻¹) 114r. A past value HCUr⁻¹ which is latched is inputted into the hysteresis central value section 113r. The steering judging section 115r outputs a steering holding signal HSD when judging the steering holding based on changing of the assist direction and the hysteresis central value HCUr, and outputs steering information STD when judging the steer-forward or the steer-backward.

The steering holding signal HSD is inputted into the logical product (AND) circuit 116, and the steering information STD is inputted into the logical sum (OR) circuit 117.

When the steering holding signals HSU and HSD are outputted as the steering holding state at the same time, the logical product (AND) circuit 116 outputs that the steering holding signal HS is “1” as the steering holding state. When the steering holding signals HSU and HSD are not outputted as the steering holding state at the same time, the logical product (AND) circuit 116 outputs that the steering holding signal HS is “0” as the steering state. When the steering informations STU and STD are outputted as the steer-forward at the same time, the logical sum (OR) circuit 117 outputs that the steering information ST is “0” as the steer-forward state. When the steering informations STU and STD are not outputted as the steer-forward at the same time, the logical sum (OR) circuit 117 outputs that the steering information ST is “1” as the steer-backward state.

The hysteresis width is set by considering following conditions (1) and (2).
(1) column input-side angle signal θs1:
   a value that is larger than a noise width of the column output-side angle signal θr1 and is smaller than a friction of the column shaft
(2) column output-side angle signal θr1:
   a value that is larger than a noise width of the column input-side angle signal θs1+a value that is smaller than 0.2 [deg] (changing by a spring rate)

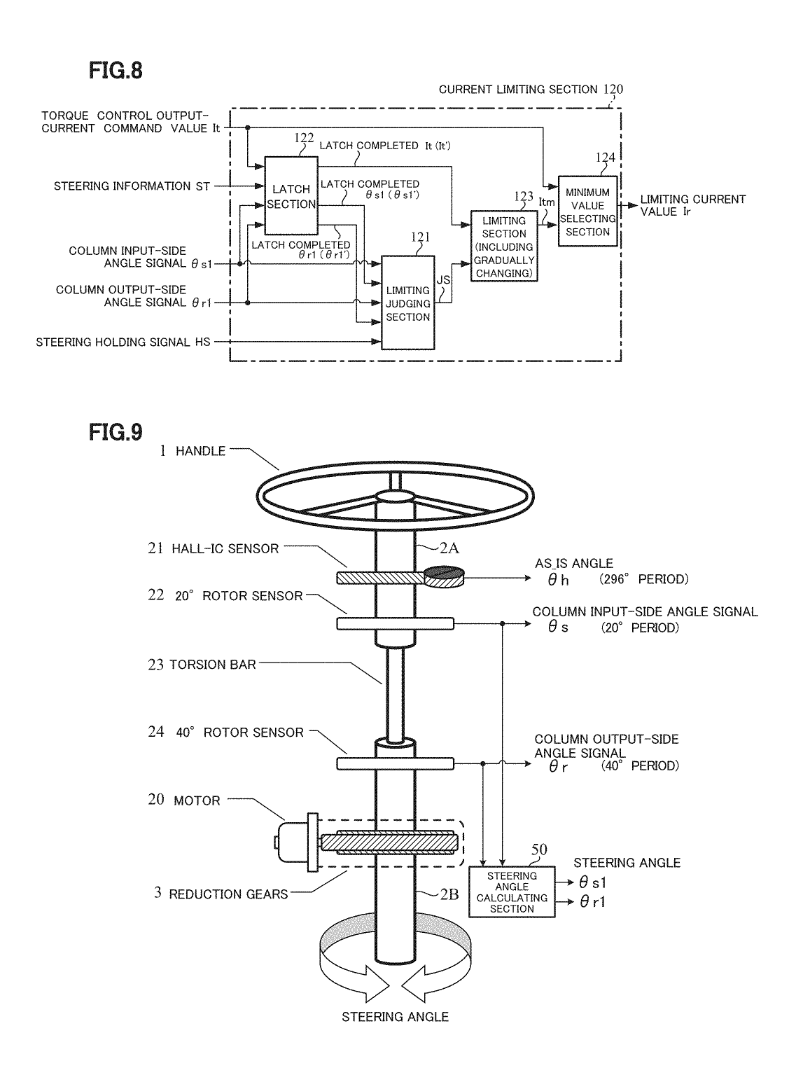

Further, the current limiting section 120 has a configuration as shown in for example, FIG. 8, and the torque control output current command value “It”, the steering information ST, the column input-side angle signal θs1 and the column output-side angle signal θr1 are inputted into a latch section 122 which performs the latch process. When the steering information ST is the steer-forward (“0”), the latch section 122 latches the torque control output current command value “It”, the column input-side angle signal θs1 and the column output-side angle signal θr1, and a column input-side angle signal θs1′ and a column output-side angle signal θr1′, which are latched, and the steering holding signal HS are inputted into a limiting judging section 121. When the steering holding signal HS is the steering holding state (“1”), a difference between the column input-side angle signal θs1′ which is latched and the column output-side angle signal θr1′ which is latched is a predetermined amount or less and a difference between the column output-side angle signal θr1′ which is latched and the column output-side angle signal θr1 is a predetermined amount or less, the limiting judging section 121 judges that the current limiting is capable, and outputs the judging signal JS. The judging signal JS and the torque control output current command value It′ which is latched are inputted into a limiting section 123 (including the gradually changing). A current Itm, which is limited at the limiting section 123, is inputted into a minimum value selecting section 124, and is compared to the torque control output current command value “It”. The smaller one is selected, and a limiting current value Ir is outputted.

When the steering state is changed from the steering holding to the steer-forward or the steer-backward, the judging signal JS cannot be controlled because the steering holding signal HS is inputted into the limiting judging section 121. The control section selects the same value of the maximum current of the system as the limiting value, and the torque control output current command value “It” is outputted as the limiting current value Ir.

In the present invention, the steering holding is judged based on the column input-side angle signal θs1 of the handle side and the column output-side angle signal θr1 of the intermediate shaft side. In the electric power steering apparatus having a torsion bar, sensors for example, which are shown in FIG. 9, are mounted to the column shaft (the handle shaft) 2, and the angle is detected. That is, a Hall-IC sensor 21 as an angle sensor, and a 20° rotor sensor 22 of the torque sensor input-side rotor are mounted to an input shaft 2A of the handle 1 side of the handle shaft 2. The Hall-IC sensor 21 outputs an AS_IS angle θh having a 296° period. The 20° rotor sensor 22 is mounted to a position where a location of the handle 1 is closer than that of the torsion bar 23, and outputs the column input-side angle signal θs having a 20° period. The column input-side angle signal θs is inputted into the steering angle calculating section 40. A 40° rotor sensor 24 of the torque sensor output-side rotor is mounted to the output shaft 2B of the handle shaft 2, a column output-side angle signal θr from the rotor sensor 24 is outputted from the 40° rotor sensor 24, and the column output-side angle signal θr is inputted into the steering angle calculating section 50. The column input-side angle signal θs and the column output-side angle signal θr are calculated to an absolute angle at the steering angle calculating section 50, and a column input-side angle signal θs1 and a column output-side angle signal θr1, which are the absolute angle, are outputted from the steering angle calculating section 50. The column input-side angle signal θs1 and the column output-side angle signal θr1 which are detected in such a manner are inputted into the steering state judging section 110 and the current limiting section 120.

Actually, the column input-side angle signal θs1 and the column output-side angle signal θr1 are outputted through an anti-roll-over process (a process that transforms a saw-tooth wave to a straight line).

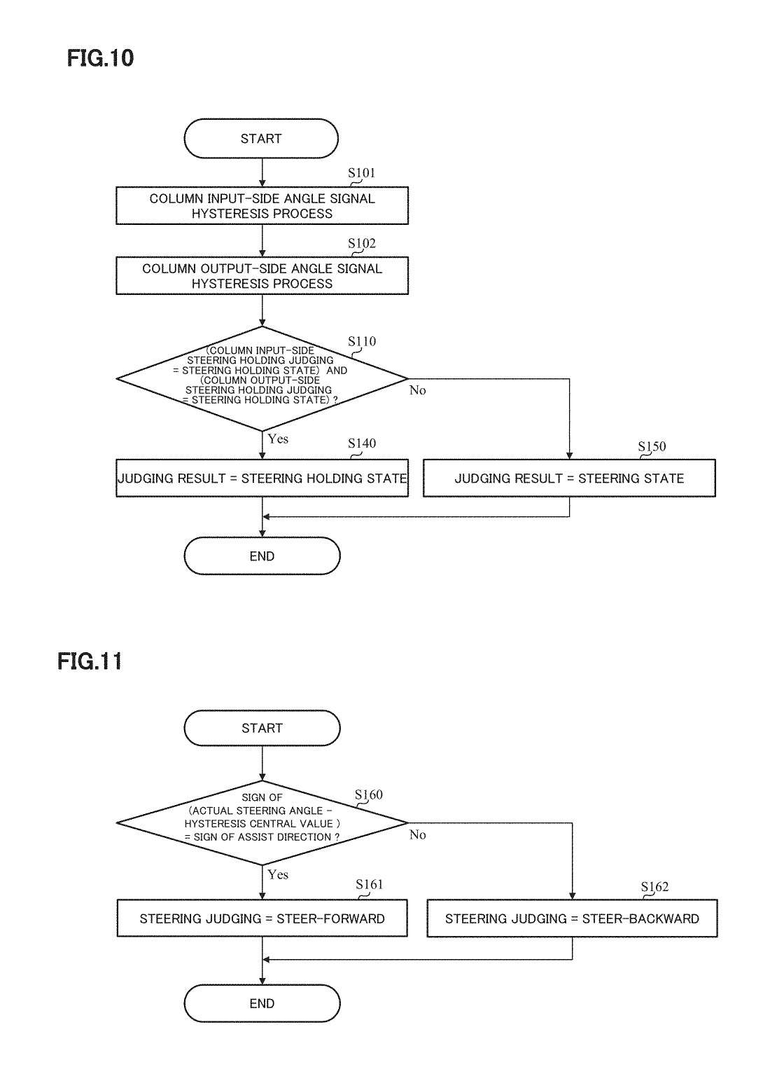

In such a configuration, an operation example of the steering state judging section 110 will be described with reference to a flowchart of FIG. 10.

At first, a hysteresis process of the column input-side angle signal θs1 is performed (Step S101). Next, a hysteresis process of the column output-side angle signal θr1 is performed (Step S102). Then, the apparatus judges whether the column input-side steering holding judging and the column output-side steering holding judging are the steering holding state at the same time, that is, whether “the column input-side steering holding judging”=“steering holding” and “the column output-side steering holding judging”=“steering holding” are satisfied (Step S110). In a case that the above conditions are coincident, the steering holding signal HS is outputted to “1” that means as the steering holding state (Step S140). In a case that the above conditions are not coincident, the steering holding signal HS is outputted to “0” that means as the steering state (Step S150).

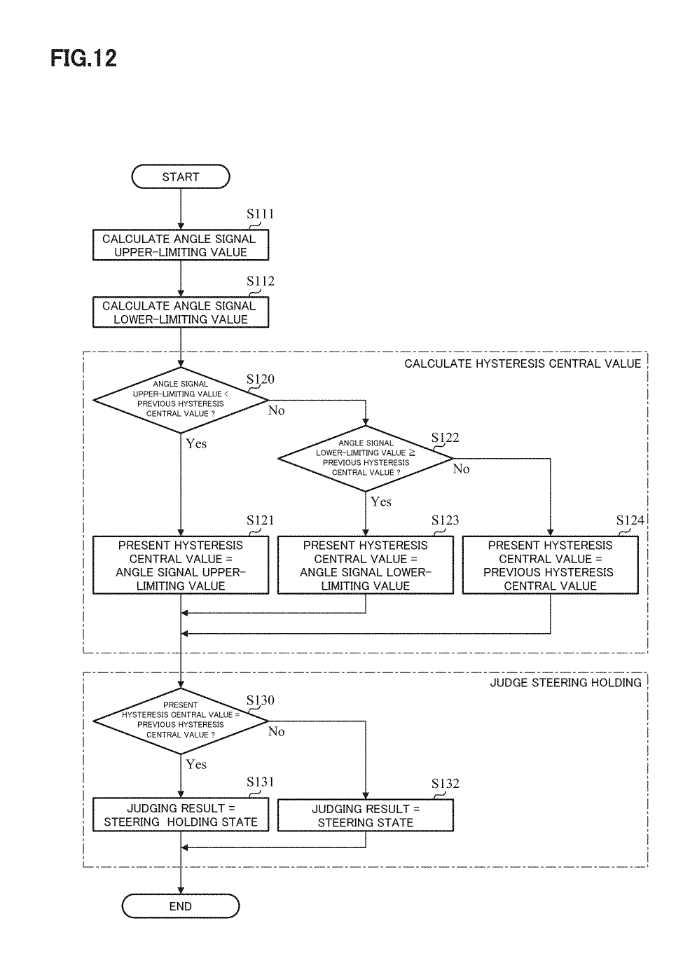

At the same time, as shown in FIG. 11, a steering judging whether the column input-side angle signal θs1 is the steer-forward or the steer-backward, and a steering judging whether the column output-side angle signal θr1 is the steer-forward or the steer-backward are performed. The apparatus judges whether the column input-side steering judging and the column output-side steering judging are the steer-forward at the same time (Step S160). In a case that the above conditions are coincident, the steering information ST is outputted to “1” that means as the steer-forward (Step S161). In a case that the above conditions are not coincident, the steering information ST is outputted to “0” that means as the steer-backward (Step S162). The steering holding signal HS and the steering information ST are inputted into the current limiting section 120.

Next, a hysteresis process of the column input-side angle signal θs1 (Step S101) and a hysteresis process of the column output-side angle signal θr1 (Step S102) in FIG. 10 will be described with reference to a flowchart of FIG. 12 and FIG. 9 in detail. Since the hysteresis process of the column input-side angle signal θs1 is the same operation as the column output-side angle signal θr1, the hysteresis process of the column input-side angle signal θs1 only will be described.

At first, the column input-side angle signal θs1 is inputted into an angle signal upper-limiting value calculating section 111s, and an angle signal upper-limiting value θUs is calculated (Step S111). The column input-side angle signal θs1 is inputted into an angle signal lower-limiting value calculating sections 112s, and an angle signal lower-limiting value θDs is calculated (Step S112). The calculation order may be changed.

The angle signal upper-limiting value θUs and the angle signal lower-limiting value θDs are inputted into a hysteresis central value calculating section 113s, and a hysteresis central value HCUs is calculated at the hysteresis central value calculating section 113s. It is judged whether the angle signal upper-limiting value θUs is smaller than a previous hysteresis central value (HCUs⁻¹) or not (Step S120). In a case that the angle signal upper-limiting value θUs is smaller than the previous hysteresis central value (HCUs⁻¹), the angle signal upper-limiting value θUs is set as a present hysteresis central value (Step S121). In the Step S120, in a case that it is judged that the angle signal upper-limiting value θUs is not smaller than the previous hysteresis central value (HCUs⁻¹) it is judged whether the angle signal lower-limiting value θDs is the previous hysteresis central value (HCUs⁻¹) or more, or not (Step S122). In a case that it is judged that the angle signal lower-limiting value θDs is the previous hysteresis central value (HCUs⁻¹) or more, the angle signal lower-limiting value θDs is set as the present hysteresis central value (Step S123). In the Step S122, in a case that it is judged that the angle signal lower-limiting value θDs is not the previous hysteresis central value (HCUs⁻¹) or more, the previous hysteresis central value is set as the present hysteresis central value (Step S124). In this manner, the hysteresis central value HCUs is calculated.

Thereafter, a steering judging section 115s which the hysteresis central value HCUs is inputted, judges whether the present hysteresis central value is coincident with the previous hysteresis central value (Step S130). In a case that the present hysteresis central value is coincident with the previous hysteresis central value, the steering holding signal HSU is outputted as the judging result (Step S131). In a case that the present hysteresis central value is not coincident with the previous hysteresis central value, the steering information STU is outputted as the judging result (Step S132).

The operation (the hysteresis process) of the column output-side angle signal θr1 is quite the same as that of the column input-side angle signal θs1. The operation (the hysteresis process) of the column output-side angle signal θr1 may be performed before or after that of the column input-side angle signal θs1.

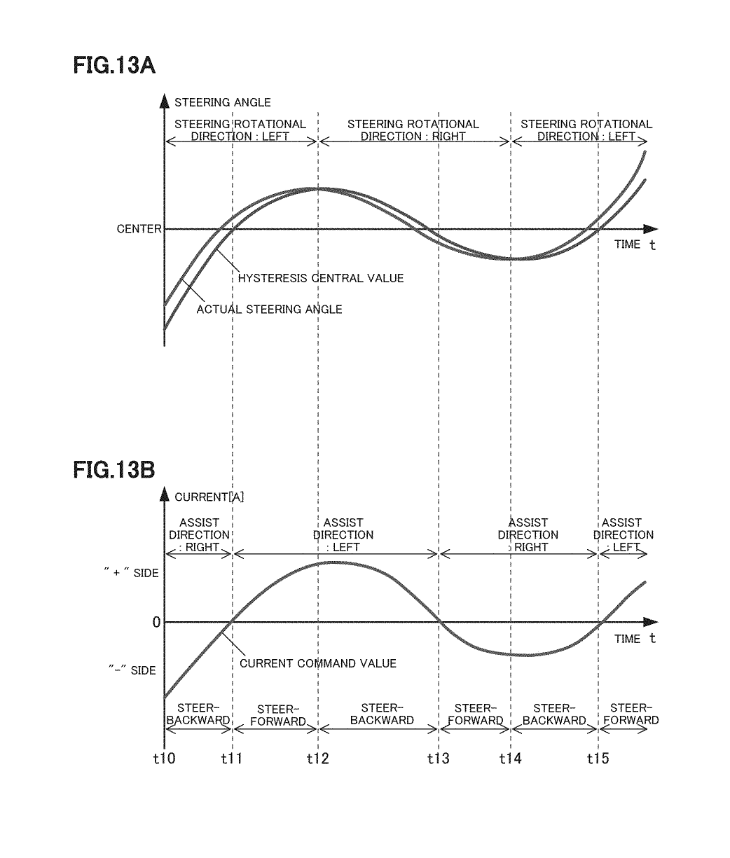

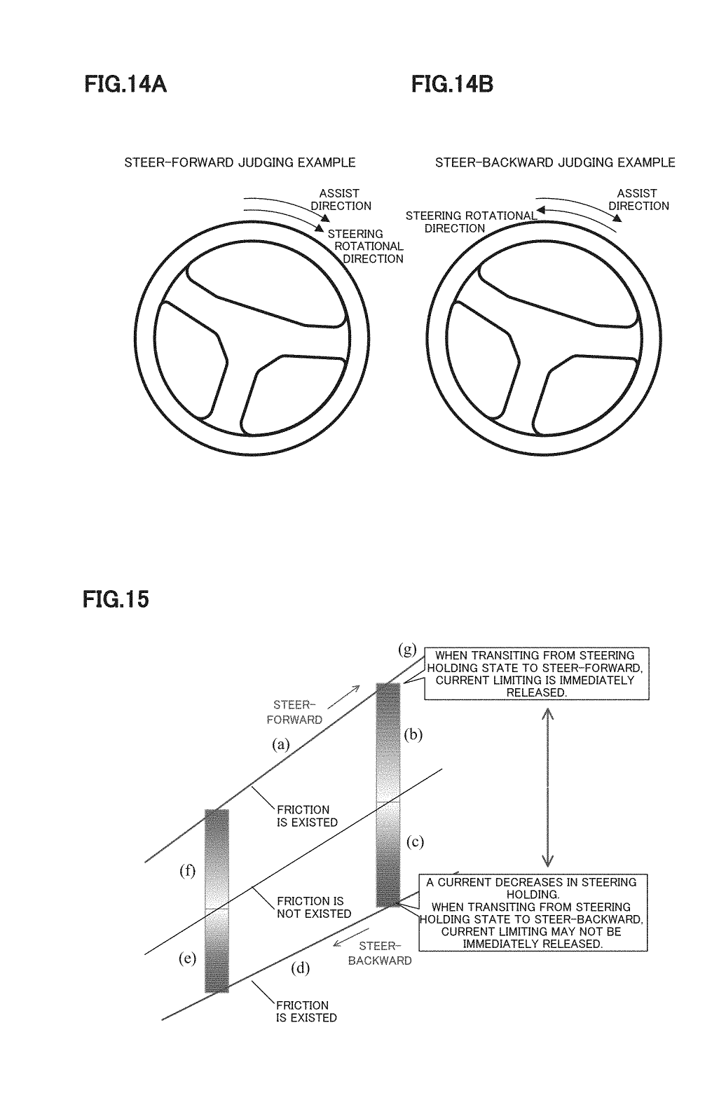

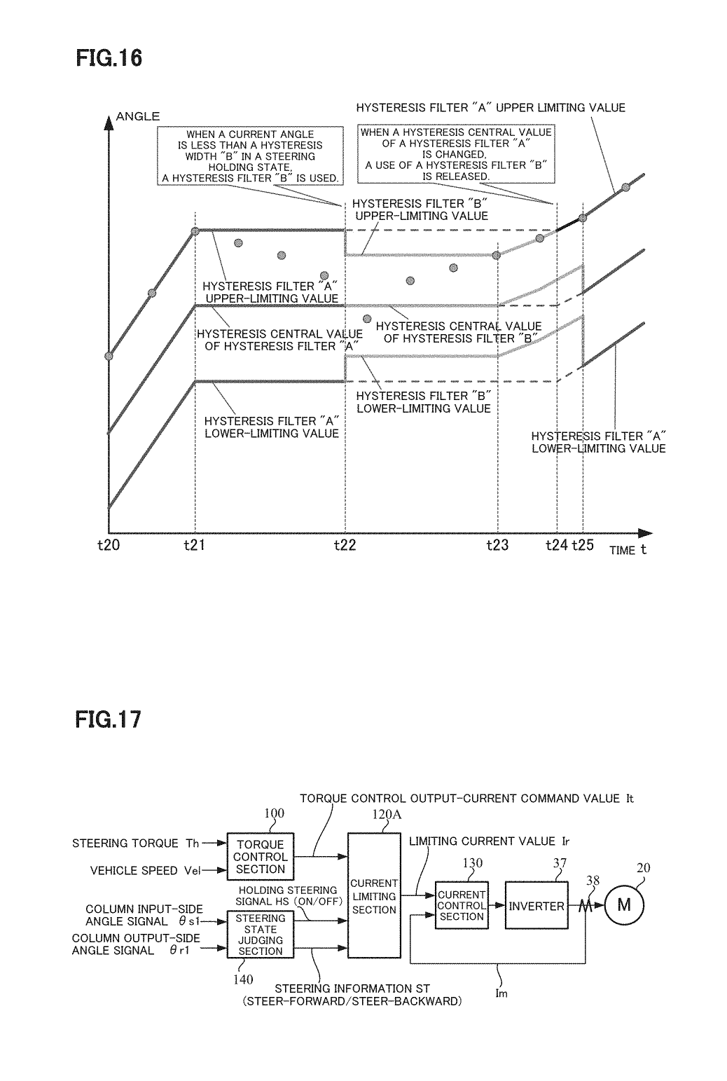

FIG. 13A shows a behavior which a steering rotational direction is detected whether the angle signal (the steering angle) is an upper side or a lower side against the hysteresis central value. FIG. 13B shows a behavior which a torque direction (the assist direction) is detected from positive and negative signs of the current command value. In the present invention, as shown in FIG. 14A and FIG. 14B, when the assist direction is coincident with the steering rotational direction, the apparatus judges the steer-forward. When the assist direction is not coincident with the steering rotational direction, the apparatus judges the steer-backward.

The operation of FIG. 12 is performed in the process of the column output-side angle signal θr1 as well.

In an example of FIG. 13A, a first steering position is a right side from a center. The steering position is changed as follows: “to the left”, “passing the center”, “further to the left”, “return to the right”, “passing the center”, and “left steering”. FIG. 13B shows a behavior which the steer-forward or the steer-backward is judged depending on a decrease or an increase of the current.

FIG. 15 shows a current limiting method. In the transition from a state (a) to a state (b), the angle and the current are latched when transiting from the steer-forward to the steering holding state, and the above current is set as a reference current value of the current limiting. In the transition from the state (b) to a state (c), the current is gradually changed and is limited, considering the friction of the column shaft, against the latched current in the steering holding state. In the current limiting, by comparing the current command value of the torque control output to the current limiting value, and outputting the minimum value, the current is limited to the minimum current to maintain the steering holding state. In the transition from the state (b) to a state (g), in a case of transiting from the steering holding state to the steer-forward, the current limiting is released, and the current is immediately changed to the torque control output value. In the transition from the state (c) to a state (d), in a case that a difference between the latched angle and a present angle is larger than a predetermined amount, the current limiting is released, and the current is immediately changed to the torque control output value. In a state (e) or a state (f), the current limiting is not performed because the current has already decreased to a current in which the steering holding state is maintained in the transition from the steer-backward to the steering holding state.

In a method for detecting the steering state by using the conventional hysteresis filter with respect to the column input-side angle signal θs1 and the column output-side angle signal θr1 in a sensor system as shown in FIG. 9, in order that it is detected that the input signal is stabilized to a constant value which is the hysteresis central value by using a particular hysteresis width, it is necessary to increase the hysteresis width. In this case, in order to immediately detect a transition from the stable state, the hysteresis width is too large. Then, in the second embodiment of the present invention, each of the input angle signals (the column input-side angle signal θs1 and the column output-side angle signal θr1) has plural hysteresis widths “A” (large) and “B” (small). By selecting the hysteresis width “A” or “B” depending on varying the state, the above problem is resolved.

In the second embodiment, as shown in FIG. 16, it is difficult to change the hysteresis central value of the hysteresis filter “A” by adopting the large hysteresis width “A” of the hysteresis filter “A” until the input angle signals (the column input-side angle signal θs1 and the column output-side angle signal θr1) are stable to some extent (a time point t21 to a time point t22). After the time point t22, when the input angle signals are more stable, it is formed that the change of the hysteresis central value of the hysteresis filter “A” is easily occurred by adopting the small hysteresis width “B” of the hysteresis filter “B” (the time point t22 to a time point t23). Thereby, it is possible to immediately detect a stability of the input angle signals, and detect the transition from the stable state by a small change. The hysteresis central value of the hysteresis filter “A” is changed at a time point t24, and the transition from the hysteresis width “B” of the hysteresis filter “B” to the hysteresis width “A” of the hysteresis filter “A” is occurred at a time point t25. The symbol “” of FIG. 16 denotes the input angle signals.

When the hysteresis width is narrowed from “A” (large) to “B” (small), it is necessary not to change the hysteresis central value due to a switch. In a case that a value between the input angle signals and the hysteresis central value is within a threshold, the hysteresis width is switched. To widen the hysteresis width from “B” (small) to “A” (large), since the change of the hysteresis central value is not treated by simply switching the hysteresis width, two hysteresis filters for the column input-side angle signal θs1 and the column output-side angle signal θr1 are prepared. In a case that respective hysteresis central values of the hysteresis width “A” and the hysteresis width “B” are changed, the hysteresis width is switched. In a case that the calculating of the hysteresis width “B” is always performed, the hysteresis central value of the hysteresis filter “A” is different from that of the hysteresis filter “B”. In this way, based on the result of the hysteresis filter “A”, only when the hysteresis trigger signal is ON, the calculating process and the judging of the hysteresis filter “B” are performed. Thereby, continuing to detect the change of the state, it is possible to switch the hysteresis width.

FIG. 17 shows a block diagram of the second embodiment. The steering torque Th and the vehicle speed Vel are inputted into the torque control section 100, and the torque control output-current command value “It”, which is calculated based on the steering torque Th and the vehicle speed Vel, is inputted into the current limiting section 120A. The column input-side angle signal θs1 and the column output-side angle signal θr1 which are outputted from the angle sensors which are provided with the column shaft, are inputted into the steering state judging section 140, and the steering holding signal HS (ON or OFF) and the steering information ST (the steer-forward or the steer-backward) which are judged at the steering state judging section 140, are inputted into the current limiting section 120A. The limiting current value Ir from the current limiting section 120A and the motor current value Im are inputted into the current control section 130 and the motor 20 are driving-controlled by the limiting current value Ir and the motor current value Im via the inverter 37.

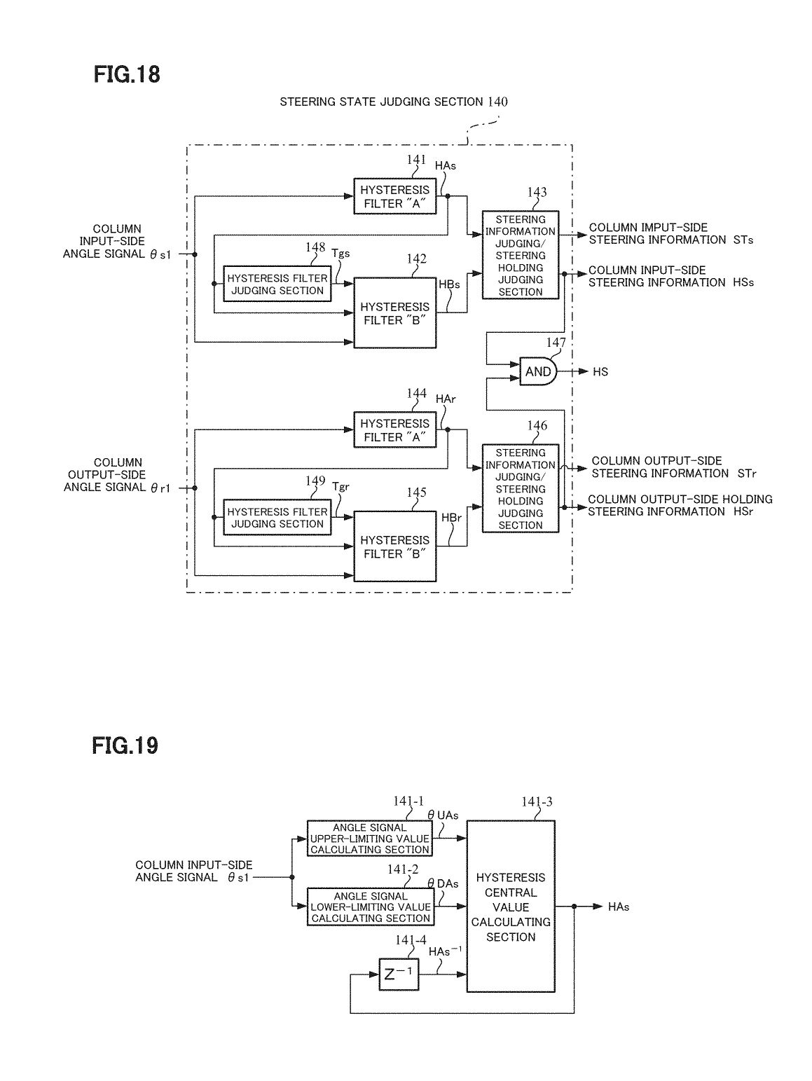

The column input-side angle signal θs1 of the handle side and the column output-side angle signal θr1 of the intermediate shaft side are inputted into the steering state judging section 140, and the steering state judging section 140 has a configuration as shown in FIG. 18 and performs the hysteresis filter process, and the steering information judging/steering holding judging. The column input-side angle signal θs1 is inputted into the hysteresis filter (A) 141 and the hysteresis filter (B) 142, and the column output-side angle signal θr1 is inputted into the hysteresis filter (A) 144 and the hysteresis filter (B) 145. A hysteresis (A) central value HAs is outputted from the hysteresis filter 141, and is inputted into the steering information judging/steering holding judging section 143, the hysteresis filter judging section 148 and the hysteresis filter (B) 142. A hysteresis trigger signal Tgs from the hysteresis filter judging section 148 is inputted into the hysteresis filter (B) 142. A hysteresis (A) central value HAr is outputted from the hysteresis filter 144, and is inputted into the steering information judging/steering holding judging section 146, the hysteresis filter judging section 149 and the hysteresis filter (B) 145. A hysteresis trigger signal Tgr from the hysteresis filter judging section 149 is inputted into the hysteresis filter (B) 145.

A hysteresis (B) central value HBs is outputted from the hysteresis filter (B) 142 which operates during the hysteresis trigger signal Tgs is inputted (ON), and is inputted into the steering information judging/steering holding judging section 143. A hysteresis (B) central value HBr is outputted from the hysteresis filter (B) 145 which operates during the hysteresis trigger signal Tgr is inputted (ON), and is inputted into the steering information judging/steering holding judging section 146.

As well, calculating initial input signals of the hysteresis filters (B) 142 and 145 are the hysteresis central values HAs and HAr from the hysteresis filters (A) 141 and 144, respectively.

Column input-side steering information STs and column input-side steering holding information HSs are outputted from the steering information judging/steering holding judging section 143, and column output-side steering information STr and column output-side steering holding information HSr are outputted from the steering information judging/steering holding judging section 146. The column input-side steering holding information HSs and the column output-side steering holding information HSr are inputted into an AND section 147 which judges a logical product condition. When both inputs are coincident, the steering holding signal HS is outputted from the AND section 147. A switching judging section comprises the steering information judging/steering holding judging sections 143 and 146, and the AND section 147.

The hysteresis filters (A) 141 and 144 are the same configuration. The column input-side angle signal θs1 will be described with reference to FIG. 19 which illustrates the hysteresis filter 141. The column input-side angle signal θs1 is inputted into an angle signal upper-limiting value calculating section 141-1 and an angle signal lower-limiting value calculating section 141-2. An angle signal upper-limiting value θUAs and an angle signal lower-limiting value θDAs are calculated at the angle signal upper-limiting value calculating section 141-1 and the angle signal lower-limiting value calculating section 141-2, respectively. The angle signal upper-limiting value θUAs and the angle signal lower-limiting value θDAs are inputted into a hysteresis central value calculating section 141-3. A portion of a hysteresis setting section comprises the angle signal upper-limiting value calculating section 141-1 and the angle signal lower-limiting value calculating section 141-2. Based on the angle signal upper-limiting value θUAs and the angle signal lower-limiting value θDAs, a hysteresis central value HAs which is calculated at the hysteresis central value calculating section 141-3, is inputted into the steering information judging/steering holding judging section 143, the hysteresis filter judging section 148 and the hysteresis filter (B) 142, and is latched at a latch section (Z⁻¹) 141-4. A past value HAS⁻¹, which is latched, is inputted into the hysteresis central value calculating section 141-3. The hysteresis central value HAs is outputted from the hysteresis central value calculating section 141-3. A hysteresis central value operating section comprises the hysteresis central value calculating section 141-3 and the latch section (Z⁻¹) 141-4.

The hysteresis filter (A) 144 into which the column output-side angle signal θr1 is inputted, is the same configuration of the hysteresis filter (A) 141.

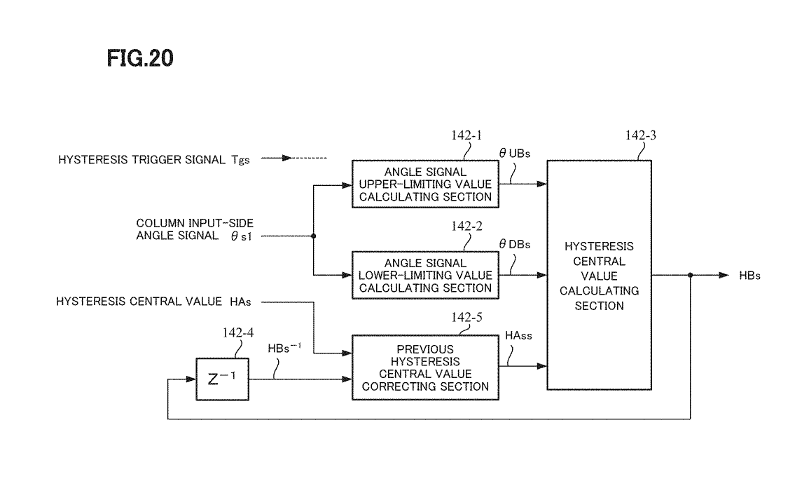

The hysteresis filters (B) 142 and 145 are the same configuration. The column input-side angle signal θs1 will be described with reference to FIG. 20 which illustrates the hysteresis filter 142. The hysteresis filter (B) 142 operates only when the hysteresis trigger signal Tgs is inputted (ON) from the hysteresis filter 148. The column input-side angle signal θs1 is inputted into an angle signal upper-limiting value calculating section 142-1 and an angle signal lower-limiting value calculating section 142-2. An angle signal upper-limiting value θUBs and an angle signal lower-limiting value θDBs are calculated at the angle signal upper-limiting value calculating section 142-1 and the angle signal lower-limiting value calculating section 142-2, respectively. The angle signal upper-limiting value θUBs and the angle signal lower-limiting value θDBs are inputted into a hysteresis central value calculating section 142-3. A portion of a hysteresis setting section comprises the angle signal upper-limiting value calculating section 142-1 and the angle signal lower-limiting value calculating section 142-2. Based on the angle signal upper-limiting value θUBs and the angle signal lower-limiting value θDBs, a hysteresis central value HBs which is calculated at the hysteresis central value calculating section 142-3, is inputted into the steering information judging/steering holding judging section 146, and is latched at a latch section (Z⁻¹) 142-4. A past value HBS⁻¹, which is latched, is inputted into a previous hysteresis central value correction section 142-5. The hysteresis central value HAs is also inputted into the previous hysteresis central value correction section 142-5. The corrected hysteresis central value Hass is inputted into the hysteresis central value calculating section 142-3. The hysteresis central value calculating section 142-3 calculates the hysteresis central value HBs, and the hysteresis central value HBs is inputted into the steering information judging/steering holding judging section 146. A hysteresis central value operating section comprises the hysteresis central value calculating section 142-3, the previous hysteresis central value correction section 142-5 and the latch section (Z⁻¹) 142-4.

The hysteresis filter (A) 145 into which the column output-side angle signal θr1 is inputted, is the same configuration of the hysteresis filter (A) 142.

The hysteresis widths are set by considering following conditions (a) and (b). The hysteresis widths have two widths “A” and “B”. Under satisfying the following conditions, the large hysteresis width “A” and the small hysteresis width “B” are set.
(a) column input-side angle signal θs1:
   a value that is larger than a noise width of the column input-side angle signal θs1 and is smaller than a friction of the column shaft (a sum of a bearing preload of a shaft, a spline engagement section of an inner shaft and an outer shaft and a mechanical gear structure portion of a worm wheel)
(b) column output-side angle signal θr1:
   a value that is larger than a noise width of the column output-side angle signal θr1+a value that is smaller than 0.1 [Nm] which a driver does not feel (changing by the spring rate of the torsion bar)

Further, as shown in FIG. 17, the torque control output current command value “It”, the steering holding signal HS and the steering signal ST from the steering state judging section 110 are inputted into the current limiting section 120A. When the transiting from the steering to the steering holding is judged, the current command value when the transiting is occurred is latched, and the current are limited. The limited current is inputted into the minimum value selecting section, and is compared to the torque control output current command value “It”. The smaller one is selected, and a limiting current value Ir is outputted. When the transiting from the steering holding to a steering state of the steer-forward or the steer-backward is occurred, the current limiting is released, and the torque control output current command value “It” is outputted as the limiting current value Ir.

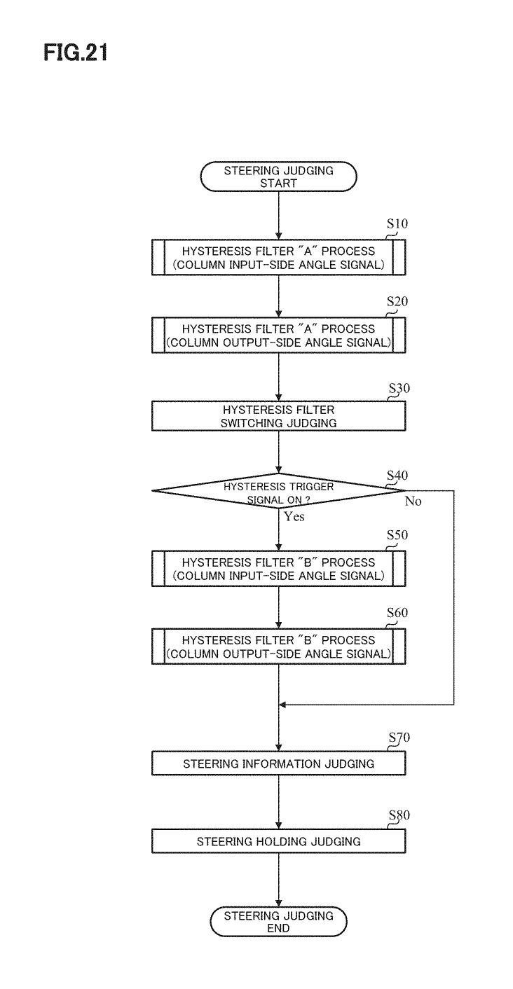

In such a configuration, an operating example of the steering state judging 140 will be described with reference to a flowchart of FIG. 21.

At first, the hysteresis filter (A) 141 performs the filter process to the column input-side angle signal θs1 (Step S10). Next, the hysteresis filter (A) 144 performs the filter process to the column output-side angle signal θr1 (Step S20). This order may be changed. Thereafter, the switching judging of the hysteresis filter “A” or “B” is performed (Step S30), and the hysteresis trigger signal Tgs or Tgr from the hysteresis filter judging section 148 or 149 is judged ON or OFF (Step S40). In a case that the hysteresis trigger signal Tgs or Tgr is ON, the hysteresis filter (B) 142 performs the filter process to the column input-side angle signal θs1 (Step S50). Next, the hysteresis filter (B) 145 performs the filter process to the column output-side angle signal θr1 (Step S60). This order may be changed. Then, the process of the steering information judging (Step S70) and the process of the steering holding judging (Step S80) are performed. In a case that the hysteresis trigger signals Tgs and Tgr are OFF, the process of the steering information judging (Step S70) and the process of the steering holding judging (Step S80) are performed, and the steering process ends.

In short, the process of the hysteresis filter “A” performs to the filter process to the column input-side angle signal θs1 and the filter process to the column output-side angle signal θr1. Then, the judging of the hysteresis filter is performed. Based on the judging result, when the filter is switched to the hysteresis filter “B”, the process of the hysteresis filter “B” is performed, and the steering holding judging and the steering judging are performed using the hysteresis central values of the hysteresis filter “A” and the hysteresis filter “B”.

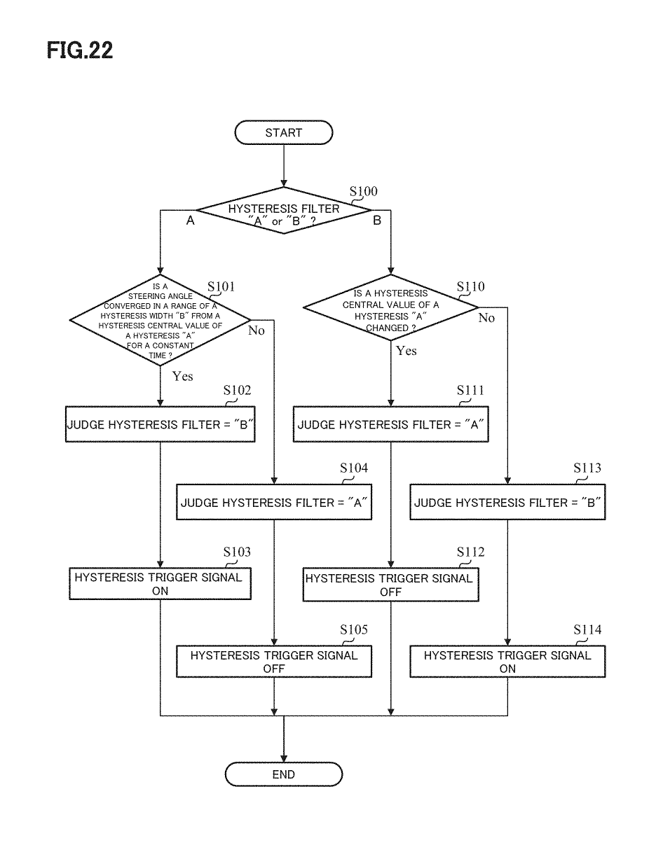

Next, the operations of the hysteresis filter judging sections 148 and 149 will be described with reference to the flowchart of FIG. 22. The operation of hysteresis filter judging section 148 is the same as that of the hysteresis filter judging section 149, and then the hysteresis filter judging section 148 will only be described.

At first, it is judged whether the hysteresis filter is “A” (141) or “B” (142) (Step S100). When the hysteresis filter is “A”, it is judged whether the steering angle is in a range of the hysteresis width “B” from the hysteresis central value of the hysteresis “A” for a constant time (Step S101). In a case that the steering angle is in a range of the hysteresis width “B” for the constant time, it is judged that the hysteresis filter is “B” (Step S102), the hysteresis trigger signal Tgs is outputted (ON) (Step S103) and the process ends. In a case that the steering angle is not in a range of the hysteresis width “B” for the constant time, it is judged that the hysteresis filter is “A” (Step S104), the hysteresis trigger signal Tgs is OFF (Step S105) and the process ends.

When the hysteresis filter is “B” in judging of the above Step S100, it is judged whether the hysteresis central value of the hysteresis “A” is changed or not (Step S110). In a case that the hysteresis central value is changed, it is judged that the hysteresis filter is “A” (Step S111), the hysteresis trigger signal Tgs is OFF (Step S112) and the process ends. In a case that the hysteresis central value is not changed, it is judged that the hysteresis filter is “B” (Step S113), the hysteresis trigger signal Tgs is outputted (ON) (Step S114) and the process ends.

The operation of the hysteresis filter judging section 149 is also the same as that of the hysteresis filter judging section 148.

The operation of the hysteresis filters (A) 141 and 144 is Steps S111 to S112 and Steps S120 to S124 described in FIG. 12. The hysteresis filters (B) 142 and 145 performs the filter process only when the hysteresis trigger signals Tgs and Tgr are inputted (ON) from the hysteresis filter judging sections 148 and 149. Therefore, as shown in FIG. 20, the correcting section 142-5 is provided. Only when the transiting from the hysteresis filters “A” to the hysteresis filters “B” is occurred, the operation is performed as follows. The previous hysteresis central value of the hysteresis filters “B” is initialized by the hysteresis central value of the hysteresis filters “A”, and the subsequent operation is the same as that of the hysteresis filters “A” 141 and 144.

In the detecting of the steering holding state, the central value of the hysteresis width (the hysteresis central value) is used. The initial value of the hysteresis central value is an average value of the steering angle upper-limiting value and the steering angle lower-limiting value, and the hysteresis central value is updated by the hysteresis filter process. The steering angle upper-limiting value and the steering angle lower-limiting value, which are set by the detected steering angle, are compared to the past value of the hysteresis central value (the previous hysteresis central value), and the update of the hysteresis central value is performed. In a case that the past value of the hysteresis central value (the hysteresis central past value) is larger than the steering angle upper-limiting value, or the hysteresis central past value is the steering angle lower-limiting value or less, the hysteresis central value is updated. In other cases, the hysteresis central value is not updated. When the hysteresis central value is not updated, it is judged that the provisional steering holding state (the provisional steering holding state) is occurred at that point. When all of the judging results (the provisional steering information), which plural steering sensors are detected to the steering angle, are the provisional steering holding state, it is detected that the steering holding state at that point. The detecting result of the steering holding state is utilized to a characteristic improvement of the current command value.

In the present invention, since the hysteresis characteristic is added to the steering angle signal, and the hysteresis width is existed in the detecting process of the steering holding state, the immediate detecting is possible without the filter process or the like even though a noise or the like is generated. Because the detecting process is performed by updating the hysteresis central value and using the plural judging results to the steering angle, few erroneously detecting has occurred, and the accurate detecting is possible.

The relationship of the above logical values “1” and “0” may be constructed by an inverse logical circuit.

In the above embodiments, the calculating process and the control are performed by using two angle informations of the column input-side and the column output-side. It is possible that an estimate value of the column output-side angle which is calculated from the column input-side angle, the steering torque and the spring rate of the torsion bar without providing with the column output-side angle detecting means, is used as an alternative of the column output-side angle. Or on the contrary, the column input-side angle may be estimated from the column output-side angle.

The column output-side angle may be estimated by utilizing a reduction ratio of a column reduction mechanism section from a motor-resolver angle, and the column input-side angle may be estimated from the steering torque and the spring rate of the torsion bar.

Further, for a simple mounting, it is possible that the column input-side angle is only used without utilizing the column output-side angle and the motor-resolver angle, and the calculating process and the control are performed. Or on the contrary, it is possible that the column output-side angle is only used without utilizing the column input-side angle, and the calculating process and the control are performed.

Furthermore, it is possible that using only the motor-resolver angle, which substitutes for the column output-side angle, estimates and is alternative of the column output-side angle from the reduction ratio of the column reduction mechanism section. Or it is possible that using only the motor rotational speed, which substitutes for the motor resolver angle, estimates and is alternative of a motor rotational angle from an integral value of the rotational speed.

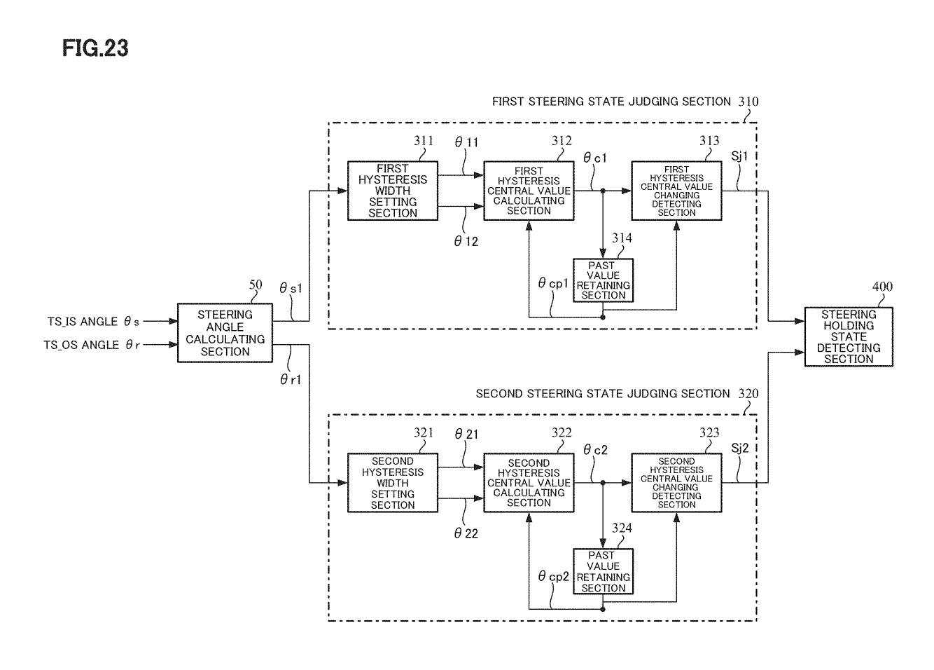

FIG. 23 is a block diagram showing a configuration example (the third embodiment) of the steering state judging section which accurately detects the steering holding state. In the third embodiment, since two steering angles are used, the apparatus comprises two steering state judging sections (the first (310) and the second (320)). As the steering angle sensors, the 20° rotor sensor 22 and the 40° rotor sensor 24 in FIG. 9 are used.

As described above, a TS_IS angle θs outputted from the 20° rotor sensor 22 and a TS_OS angle θr outputted from the 40° rotor sensor 24 are inputted into the steering angle calculating section 50. The steering angle calculating section 50 calculates absolute angles and outputs the steering angles θs1 and θr1.

A first steering state judging section 310 comprises a first hysteresis width setting section 311, a first hysteresis central value calculating section 312, a first hysteresis central value changing detecting section 313 and a past value retaining section 314. The first hysteresis width setting section 311 adds a predetermined value to the steering angle θs1 or subtracts a predetermined value from the steering angle θs1, and calculates the steering angle upper-limiting value and the steering angle lower-limiting value. The first hysteresis central value calculating section 312 calculates the hysteresis central value from the steering angle upper-limiting value, the steering angle lower-limiting value and a hysteresis central past value which is retained at the past value retaining section 314. The calculated hysteresis central value is inputted into the past value retaining section 314 and the first hysteresis central value changing detecting section 313. The first hysteresis central value changing detecting section 313 compares the inputted hysteresis central value to the hysteresis central past value which is retained at the past value retaining section 314, judges the steering state and outputs provisional steering information. In similar to the first steering state judging section 310, the second steering state judging section 320 comprises a second hysteresis width setting section 321, a second hysteresis central value calculating section 322, a second hysteresis central value changing detecting section 323 and a past value retaining section 324, and performs the similar processes to the steering angle θr1.

The steering holding state detecting section 400 detects the steering holding state based on a provisional steering information which is outputted from the first steering state judging section 310 and the second steering state judging section 320.

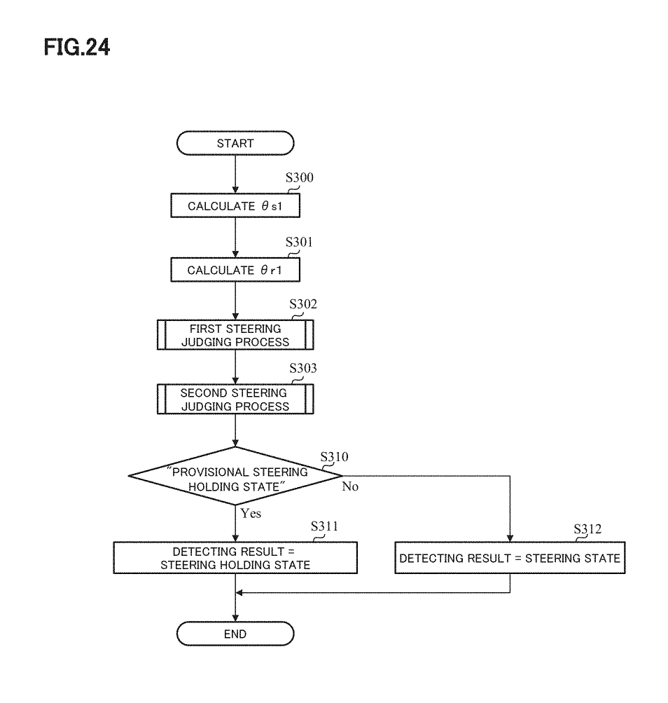

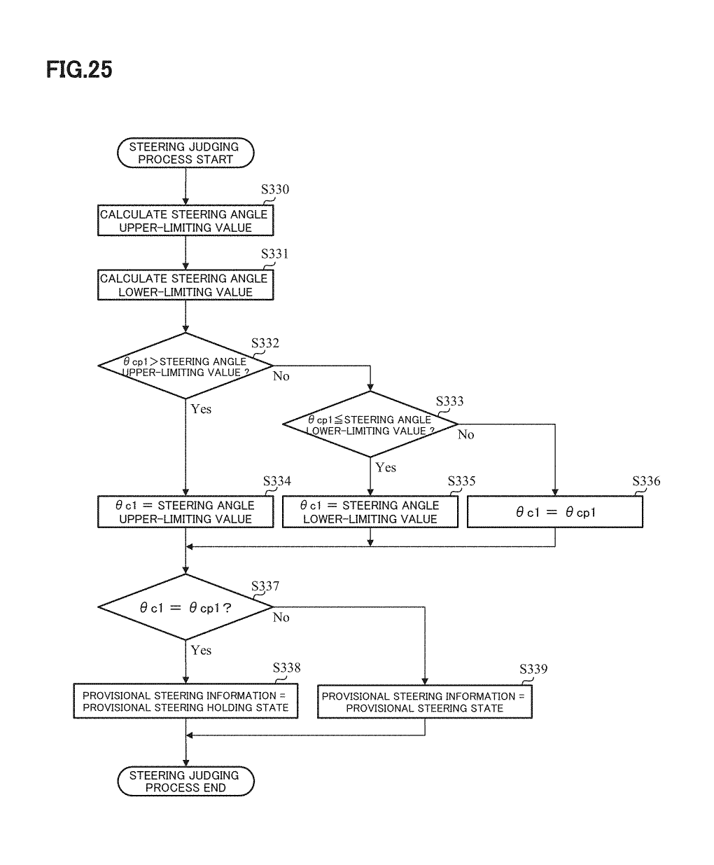

In such a configuration, the operating example will be described with reference to flowcharts of FIG. 24 and FIG. 25.

The steering angle calculating section 50 calculates the steering angle θs1 (Step S300), outputs the steering angle θs1 to the first hysteresis width setting section 311, calculates the steering angle θr1 (Step S301) and outputs the steering angle θr1 to the second hysteresis width setting section 321. The first steering state judging section 310 performs the first steering judging process using the steering angle θs1 (Step S302).

The first hysteresis width setting section 311 adds a predetermined value R1 (hereinafter referred to as a “first hysteresis width parameter”) to the steering angle θs1, and calculates the steering angle upper-limiting value θ11 (=θs1+R1) (Step S330). The first hysteresis width setting section 311 subtracts the first hysteresis width parameter R1 from the steering angle θs1, and calculates the steering angle lower-limiting value θ12 (=θs1−R1) (Step S331).

The steering angle upper-limiting value θ11 and the steering angle lower-limiting value θ12 are inputted into the first hysteresis central value calculating section 312. The first hysteresis central value calculating section 312 compares the steering angle upper-limiting value en to the hysteresis central past value θcp1 which is retained at the past value retaining section 314 (Step S332). When “θcp1>θ11”, the steering upper-limiting value θ11 is set as the hysteresis central value θc1 (Step S334). When “θcp1≦θ11”, the hysteresis central past value θcp1 is compared to the steering angle lower-limiting value θ12 (Step S333). When “θcp1≦θ12”, the steering lower-limiting value θ12 is set as the hysteresis central value θc1 (Step S335). When “θcp1>θ12”, the hysteresis central past value θcp1 is set as the hysteresis central value θc1 (Step S336).

In a case that the steering angle upper-limiting value θ11 and the steering angle lower-limiting value θ12 are data calculated from the initial steering angle θs1 which is detected at a time of starting the steering angle detecting, an average value of the steering angle upper-limiting value θ11 and the steering angle lower-limiting value θ12 (=(θ11+θ12)/2) is set as the hysteresis central value θc1 . In a case of the third embodiment, since “θ11=θs1+R1” and “θ12=θs1−R1”, the initial hysteresis central value θc1 is θs1.

The hysteresis central value θc1 is outputted to the first hysteresis central value changing detecting section 313 and the past value retaining section 314. The first hysteresis central value changing detecting section 313 compares the hysteresis central past value θcp1, which is retained at the past value retaining section 314, to the hysteresis central value θc1 (Step S337). In a case that the hysteresis central value θc1 is equal to the hysteresis central past value θcp1, provisional steering information Sj1 is outputted as “provisional steering holding state” (Step S338). In a case that the hysteresis central value θc1 is not equal to the hysteresis central past value θcp1, the provisional steering information Sj1 is outputted as “provisional steering state” (Step S339).

The second steering state judging section 320 performs the second steering judging process using the steering angle θr1 (Step S303). Since the second steering judging process is almost the same as the first steering judging process, the description is omitted. In calculating the steering angle value θ21 and the steering angle value θ22, a predetermined value R2 (hereinafter referred to as a “second hysteresis width parameter”) is used, and the steering angle value θ21 and the steering angle value θ22 calculate as “θ21=θr1+R2” and “θ22=θr1−R2”, respectively.

The provisional steering information Sj1 which is outputted from the first hysteresis central value changing detecting section 313 and the provisional steering information Sj2 which is outputted from the second hysteresis central value changing detecting section 323 are inputted into the steering holding state detecting section 400. The steering holding state detecting section 400 compares the provisional steering information Sj1 to the provisional steering information Sj2 (Step S310). In a case that the provisional steering information Sj1 and Sj2 are “provisional steering holding state”, the detecting result is set as “steering holding state” (Step S311). In a case other than the above case, the detecting result is set as “steering state” (Step S312).

An effect of detecting the steering holding state according to the present embodiment is described in comparison with a method for detecting the steering holding state using a conventional fixed threshold. Here, the operation of the first steering state judging section 310 is described. The detecting of the steering holding state is also performed by using the provisional steering information Sj2 which is the judging result of the second steering state judging section 320. Since the effect of the present invention is described in comparison with the conventional method, for the description being prevented from becoming redundant, the description is carried out as the provisional steering information Sj2 is the same as the provisional steering information Sj1. Then, when the provisional steering information Sj1 is “provisional steering holding state”, the detecting result is set as “steering holding state”. When the provisional steering information Sj1 is “provisional steering state”, the detecting result is set as “steering state”.

Prior to the description, a comparison of the hysteresis central past value θcp1 and the steering angle upper-limiting value θ11 (Step S332), and a comparison of the hysteresis central past value θcp1 and the steering angle lower-limiting value θ12 (Step S333), which the first hysteresis central value calculating section 312 performs, converts to Equation 1 using θ11=θs1+R1 and θ12=θs1−R1.

if θs1<θcp1−R1, then θc1=steering angle upper-limiting value,

if θcp1−R1<θs1<θcp1+R1, then θc1=θcp1,

if θcp1+R1<θs1, then θc1=steering angle lower-limiting value. [Equation 1]

That is, in a case that the steering angle θs1 (actual steering angle) outputted from the steering angle calculating section 50 is in a range of “θcp1−R1” (hereinafter referred to as a “past lower-limiting value”) to “θcp1+R1” (hereinafter referred to as a “past upper-limiting value”), the hysteresis central value θcp1 is not updated. In a case that the steering angle θs1 is not in a range of “θcp1−R1” to “θcp1+R1”, the hysteresis central value θcp1 is updated to the steering angle upper-limiting value or the steering angle lower-limiting value. When the hysteresis central value θcp1 is not updated, the first hysteresis central value changing detecting section 313 judges “provisional steering holding state”. When the hysteresis central value θcp1 is updated, the first hysteresis central value changing detecting section 313 judges “provisional steering state”. Summarizing the conditions and the results, the overall result is expressed by a following Equation 2.

if actual steering angle<past lower-limiting value, then hysteresis central value =steering angle upper-limiting value in “steering state”,

if past upper-limiting value<actual steering angle<past upper-limiting value, then hysteresis central value is not updated in “steering holding state”,

if past lower-limiting value<actual steering angle, then hysteresis central value=steering angle lower-limiting value in “steering state”.

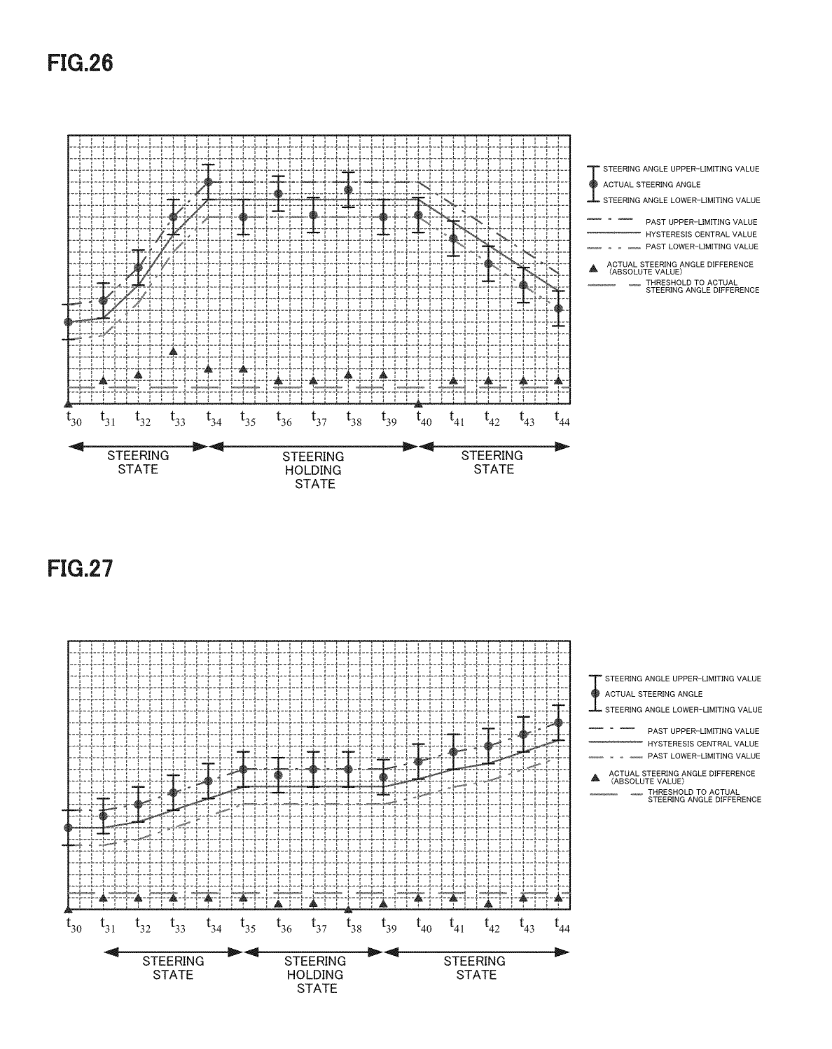

FIG. 26 and FIG. 27 are diagrams showing an example of changing the actual steering angle, the hysteresis central value and the like. FIG. 26 shows the changing in a case of generating a noise in the steering holding. FIG. 27 shows the changing in a case of slowly steering.

At first, it is described about FIG. 26. In FIG. 26, the steering holding is between a time t₃₅ and a time t₄₀, and the actual steering angle is trembling due to the noise and the like.

At a time point t₃₁, the hysteresis central past value is the actual steering angle at a time t₃₀, and the past upper-limiting value and the past lower-limiting value are the steering angle upper-limiting value and the steering angle lower-limiting value at a time point t₃₀. Then, since the actual steering angle at a time point t₃₁ is larger than the past upper-limiting value, it is “steering state” at the time point t₃₁ and the hysteresis central value is updated to the steering angle lower-limiting value at the time point t₃₁.

At a time point t₃₂, the hysteresis central past value is the steering angle lower-limiting value at the time point t₃₁ . The past upper-limiting value is a value which adds the first hysteresis width parameter R1 to the hysteresis central past value, and the past lower-limiting value is a value which subtracts the first hysteresis width parameter R1 from the hysteresis central past value. Then, since the actual steering angle at the time point t₃₂ is larger than the past upper-limiting value, it is also “steering state” at a time t₃₂ and the hysteresis central value is updated to the steering angle lower-limiting value at the time point t₃₂.

At time points t₃₃ and t₃₄, the circumstances are almost the same as the above case, it is also “steering state” and the hysteresis central value is updated to the steering angle lower-limiting value.

At a time point t₃₅, the hysteresis central past value is the steering angle lower-limiting value at the time point t₃₄. The past upper-limiting value is a value which adds the first hysteresis width parameter R1 to the hysteresis central past value, and the past lower-limiting value is a value which subtracts the first hysteresis width parameter R1 from the hysteresis central past value. Since the actual steering angle at the time point t₃₅ is in a range of the past lower-limiting value to the past upper-limiting value, it is “steering holding state” at the time point t₃₅ and the hysteresis central value is not updated. The almost same circumstances are continued for a time point t₃₆ to a time point t₄₀, it is “steering holding state” for these times and the hysteresis central value is not updated.

At a time point t₄₁, the hysteresis central past value remains the steering angle lower-limiting value at the time point t₃₄. The past upper-limiting value is a value which adds the first hysteresis width parameter R1 to the hysteresis central past value, and the past lower-limiting value is a value which subtracts the first hysteresis width parameter R1 from the hysteresis central past value. Since the actual steering angle at the time point t₄₁ is smaller than the past lower-limiting value, it is “steering state” at the time point t₄₁ and the hysteresis central value is updated to the steering angle upper-limiting value. After a time point t₄₂, because the same circumstances are continued, it is “steering state” and the hysteresis central value is updated to the steering angle upper-limiting value.

In this way, according to the present embodiment, it is judged “steering holding state” from the time point t₃₅ to the time point t₄₀, it is judged “steering state” for a time other than the time point t₃₅ to the time point t₄₀ and then it can be accurately detected in the steering holding state. In FIG. 26, a solid line, a one-dot chain line, and a two-dot chain line denote a line connecting the hysteresis central value, a line connecting the past upper-limiting value, and a line connecting the past lower-limiting value for respective times, respectively. Seeing this figure, it is understood that the hysteresis central value and the like follow the actual angle without affected by a trembling of the actual steering angle.

On the other hand, in a method for detecting the steering holding state using a fixed threshold, it cannot be accurately detected in the steering holding. For example, in a case that the threshold is set to a difference of the actual steering angle (the absolute value), the threshold is set as values which are denoted by a broken line of FIG. 26 in order that the state at a time t₃₁ is judged “steering state”. Since the trembling is occurred in the actual steering angle of the steering holding due to the noise or the like, it is erroneously judged that the state for the time point t₃₅ to the time point t₃₉ is judged “steering state”. When the threshold is set a larger value for being judged “steering holding state” for the time point t₃₅ to the time point t₃₉, it is erroneously judged that the state which is in the steering state except for a time t₃₃ is “steering holding state”. When the noise or the like is removed by using a low pass filter in order to resolve these erroneously judging, a delay is occurred in this process and then it takes a time to detect the steering holding state.

Next, FIG. 27 will be described. In FIG. 27, it is in the steering holding from the time point t₃₆ to the time point t₃₉, and it is slowly steering for a time other than the time point t₃₆ to the time point t₃₉.

At a time t₃₁, the hysteresis central past value is the actual angle at a time t₃₀. The past upper-limiting value and the past lower-limiting value at a time t₃₁ are the steering angle upper-limiting value and the steering angle lower-limiting value at the time point t₃₀. Since the actual steering angle at the time point t₃₁ is between the past lower-limiting value and the past upper-limiting value, it is “steering holding state” at a time t₃₁ and the hysteresis central value is not updated.

At the time point t₃₂, the hysteresis central past value remains the steering angle lower-limiting value at the time point t₃₀. The past upper-limiting value is a value which adds the first hysteresis width parameter R1 to the hysteresis central past value, and the past lower-limiting value is a value which subtracts the first hysteresis width parameter R1 from the hysteresis central past value. Since the actual steering angle at the time point t₃₂ is larger than the past upper-limiting value, it is “steering state” at a time t₃₂ and the hysteresis central value is updated to the steering angle lower-limiting value at the time point t₃₂. The almost same circumstances are continued for the time point t₃₃ to the time point t₃₅, it is “steering state” for these times and the hysteresis central value is updated to the steering angle lower-limiting value.

At the time point t₃₆, the hysteresis central past value is the steering angle lower-limiting value at the time point t₃₅. The past upper-limiting value is a value which adds the first hysteresis width parameter R1 to the hysteresis central past value, and the past lower-limiting value is a value which subtracts the first hysteresis width parameter R1 from the hysteresis central past value. Since the actual steering angle at a time point t₃₆ is between the past lower-limiting value and the past upper-limiting value, it is “steering holding state” at a time t₃₆, and the hysteresis central value is not updated. The almost same circumstances are continued for a time point t₃₇ to a time point t₃₉, it is “steering holding state” for this duration and the hysteresis central value is not updated.

At the time point t₄₀, the hysteresis central past value remains the steering angle lower-limiting value at the time point t₃₅. The past upper-limiting value is a value which adds the first hysteresis width parameter R1 to the hysteresis central past value, and the past lower-limiting value is a value which subtracts the first hysteresis width parameter R1 from the hysteresis central past value. Since the actual steering angle at the time point t₄₀ is larger than the past upper-limiting value, it is “steering state” at a time t₄₀ and the hysteresis central value is updated to the steering angle lower-limiting value. After a time t₄₁, because the same circumstances are continued, it is “steering state” and the hysteresis central value is updated to the steering angle lower-limiting value.

In this way, according to the present invention, it is judged “steering holding state” from the time point t₃₆ to the time point t₃₉, and then it can be accurately judged “steering state” for a time other than the time point t₃₆ to the time point t₃₉. In FIG. 27 as well as FIG. 26, the solid line, the one-dot chain line, and the two-dot chain line denote a line connecting the hysteresis central value, a line connecting the past upper-limiting value, and a line connecting the past lower-limiting value for respective times, respectively. It is understood that the hysteresis central value and the like follow in response to changing the actual steering angle.

On the other hand, in a method for detecting the steering holding state using a fixed threshold, it cannot be accurately detected in the steering holding. In a case that the threshold is set to a difference of the actual steering angle (absolute value), as well as in a case of FIG. 26, when the threshold is set as values which are denoted by a broken line of FIG. 27 in order that the state for the time point t₃₆ to the time point t₃₉ is judged “steering holding state”, it is erroneously judged that the states for the time point t₃₁ to the time point t₃₅ and after the time point t₄₀ are judged “steering holding state”.

In the third embodiment, the apparatus comprises two steering state judging sections. The two steering state judging sections can be combined to one steering state judging section and the one steering state judging section may perform the process to the steering angles θs1 and θr1. The steering angles which are used for detecting the steering holding state may increase. Further, although the same predetermined value is used in calculating of the steering angle upper-limiting value and the steering angle lower-limiting value, different predetermined values may be used. The first hysteresis width parameter R1 may be the same as the second hysteresis width parameter R2. In a case that the hysteresis central value is the same as the hysteresis central past value, the provisional steering information is set as “provisional steering holding state”. Even in a case that a difference between the hysteresis central value and the hysteresis central past value is slight, the provisional steering information may be set as “provisional steering holding state”.

### EXPLANATION OF REFERENCE NUMERALS

1 handle (steering wheel)
2 column shaft (steering shaft, handle shaft)
10 torque sensor
14 steering angle sensor
20 motor
21 Hall IC sensor
22 20° rotor sensor
24 40° rotor sensor
30 control unit (ECU)
31 current command value calculating section
33, 120, 120A current limiting section
50 steering angle calculating section
100 torque control section
100A sign judging section
110, 140 steering state judging section
130 current control section
143, 146 steering information judging/steering holding judging section
310, 320 steering state judging section
311, 321 hysteresis width setting section
312, 322 hysteresis central value calculating section
313, 323 hysteresis central value changing detecting section
400 steering holding state detecting section

1-13. (canceled)

14. A steering holding judging apparatus for a vehicle, comprising:
at least two steering angle sensors to detect a steering angle of a steering system of a vehicle; and
a steering state judging section to calculate a hysteresis central value by using a hysteresis signal that sets a hysteresis width for steering signals from said two steering angle sensor, judge a steering state by using said hysteresis central value, and output a provisional steering information,
wherein said hysteresis central value is calculated by a hysteresis filter process using said hysteresis signal,
wherein said hysteresis width is set by being added or being subtracted a value 1 which is larger than a noise width of said steering angle signal and is smaller than a friction of a column shaft, to or from a steering angle 1 detected from a steering sensor which detects an input side steering angle of said column shaft, and being added or being subtracted a value 2 which is added a value which a driver does not feel to a value which is larger than a noise width of said steering angle, to or from a steering angle 2 detected from a steering sensor which detects an output side steering angle of said column shaft, and
wherein a steering holding state is detected based on said provisional steering information.

15. The steering holding judging apparatus for the vehicle according to claim 14, wherein in a case that said hysteresis central value is same as a past value of said hysteresis central value, said steering state judging section sets said provisional steering information as a provisional steering state and said hysteresis central value is calculated by using an upper limiting value and a lower limiting value of said hysteresis signal instead of said hysteresis filter process.

16. An electric power steering apparatus equipped with said steering holding judging apparatus for said vehicle according to claim 14, wherein said electric power steering apparatus assist-controls based on a torque control output current command value from a torque control section and a judging result of said steering state judging section.

17. A steering holding judging apparatus for a vehicle, comprising:
a control unit to control a motor, which is coupled to a steering system of a vehicle, by means of a driving current;
a steering angle detecting means to detect a column input-side angle and a column output-side angle of said steering system, and output a column input-side angle signal and a column output-side angle signal;
a steering state judging section to output a steering information and a steering holding signal of said steering system based on said column input-side angle signal and said column output-side angle signal; and
a current limiting section to limit said driving current based on said steering information and said steering holding signal,
wherein said steering state judging section comprises:
a hysteresis width setting section to calculate and set hysteresis widths “A” and “B” (<“A”) to said column input-side angle signal and said column output-side angle signal, respectively;
a hysteresis central value calculating section to calculate respective hysteresis central values of said hysteresis widths “A” and “B”;
a hysteresis filter judging section to turn-ON or turn-OFF a hysteresis trigger signal based on said hysteresis central value of said hysteresis width “A”; and
a switching judging section to output said steering information and said steering holding signal based on said hysteresis central value of said hysteresis width “A” when said hysteresis signal is OFF, and said hysteresis central values of said hysteresis widths “A” and “B” when said hysteresis signal is ON.

18. The steering holding judging apparatus for the vehicle according to claim 17, wherein said switching judging section comprises:
a steering information judging/steering holding judging sections to output said steering information and said steering holding information based on said hysteresis central value of said hysteresis width “A” or , said hysteresis central values of said hysteresis widths “A” and “B”; and
a logical product section to output said steering holding signal by a logical product of said steering holding information,
wherein said hysteresis filter judging section, in a case that said hysteresis width “A” is selected, turns-ON said hysteresis trigger signal when said column input-side angle signal and said column output-side angle signal are in a range of said hysteresis width “B” from said hysteresis central value of said hysteresis width “A”, and in a case that said hysteresis width “B” is selected, turns-OFF said hysteresis trigger signal when said hysteresis central value of said hysteresis width “A” is changed, and turns-ON said hysteresis trigger signal when said hysteresis central value of said hysteresis width “A” is not changed.

19. The steering holding judging apparatus for the vehicle according to claim 17, wherein a previous hysteresis central value to said hysteresis width “B” is initialized to a hysteresis central value of said hysteresis width “A” only when it is transited from said hysteresis width “A” to said hysteresis width “B”, said hysteresis widths “A” and “B” to said column input-side angle signal are larger than a noise width of an angle signal and are smaller than a friction of a column of said steering shaft, and said hysteresis widths “A” and “B” to said column output-side angle signal are a numerical value which a value smaller than a torque which a driver does not feel is added to a value larger than a noise width of an angle signal.

20. The steering holding judging apparatus for the vehicle according to claim 18, wherein a previous hysteresis central value to said hysteresis width “B” is initialized to a hysteresis central value of said hysteresis width “A” only when it is transited from said hysteresis width “A” to said hysteresis width “B”, said hysteresis widths “A” and “B” to said column input-side angle signal are larger than a noise width of an angle signal and are smaller than a friction of a column of said steering shaft, and said hysteresis widths “A” and “B” to said column output-side angle signal are a numerical value which a value smaller than a torque which a driver does not feel is added to a value larger than a noise width of an angle signal.

21. An electric power steering apparatus equipped with said steering holding judging apparatus for said vehicle according to claim 17, wherein said electric power steering apparatus assist-controls based on a torque control output current command value from a torque control section and a judging result of said steering state judging section.

22. An electric power steering apparatus that assist-controls a steering system by calculating a torque control output current command value based on at least steering torque, and driving a motor based on said torque control output current command value, comprising:
an angle detecting means to output a column input-side angle signal and a column output-side angle signal of said steering system;
a steering state judging section to judge a steering state based on said column input-side angle signal and said column output-side angle signal, and output a steering holding signal and steering information; and
a current limiting section to limit said torque control output current command value based on said column input-side angle signal, said column output-side angle signal, said steering holding signal and said steering information,
wherein said steering state judging section comprises:
a hysteresis width setting section for said column input-side angle signal;
a hysteresis width setting section for said column output-side angle signal;
a calculating section for said column input-side angle signal to calculate a hysteresis central value to said hysteresis width;
a calculating section for said column output-side angle signal to calculate a hysteresis central value to said hysteresis width;
a judging section for said column input-side angle signal to judge a steering holding and a steer-forward or a steer-backward; and
a judging section for said column output-side angle signal to judge a steering holding and a steer-forward or a steer-backward, and
said current limiting section performs a current limiting of said torque control output current command value in a range of a current which a steering holding state is maintained.

23. The electric power steering apparatus according to claim 22, wherein said hysteresis width for said column input-side angle signal is set to a numerical value that are larger than a noise width of said column output-side angle signal and are smaller than a friction of a column shaft, and said hysteresis width for said column output-side angle signal is set to a numerical value that is a value, which an angle is smaller than that of being felt a uncomfortable steering, is added to a value larger than a noise width of said column input-side angle signal.

24. The electric power steering apparatus according to claim 22, wherein said steering state judging section outputs a steering holding state when said judging section for said column input-side angle signal and said judging section for said column output-side angle signal judge said steering holding at same time, and
said judging section for said column input-side angle signal and said judging section for said column output-side angle signal comprise
a steering judging section for said column input-side angle signal to output a column input-side steering holding signal and column input-side steering information;
a steering judging section for said column output-side angle signal to output a column output-side steering holding signal and column output-side steering information; and
a logical circuit to output said steering holding signal and said steering information by a logical calculating of said column input-side steering holding signal and said column output-side steering holding signal, and said column input-side steering information and said column output-side steering information.

25. The electric power steering apparatus according to claim 23, wherein said steering state judging section outputs a steering holding state when said judging section for said column input-side angle signal and said judging section for said column output-side angle signal judge said steering holding at same time, and
said judging section for said column input-side angle signal and said judging section for said column output-side angle signal comprise
a steering judging section for said column input-side angle signal to output a column input-side steering holding signal and column input-side steering information;
a steering judging section for said column output-side angle signal to output a column output-side steering holding signal and column output-side steering information; and
a logical circuit to output said steering holding signal and said steering information by a logical calculating of said column input-side steering holding signal and said column output-side steering holding signal, and said column input-side steering information and said column output-side steering information.

26. The electric power steering apparatus according to claim 24, wherein in said steering holding state, said electric power steering apparatus latches said torque control output current command value,
performs said current limiting by gradually changing a current command value, which is considered in a friction of a column shaft, based on a latched torque control output current control value,
in said current limiting, compares said torque control output current control value to said current limiting value,
limits to a minimum current to maintain said steering holding state by outputting a minimum one,
in a case of transiting from said steering holding state to said steer-forward, releases said current limiting, and
immediately changes to said torque control output current control value.

27. The electric power steering apparatus according to claim 25, wherein in said steering holding state, said electric power steering apparatus latches said torque control output current command value,
performs said current limiting by gradually changing a current command value, which is considered in a friction of a column shaft, based on a latched torque control output current control value,
in said current limiting, compares said torque control output current control value to said current limiting value,
limits to a minimum current to maintain said steering holding state by outputting a minimum one,
in a case of transiting from said steering holding state to said steer-forward, releases said current limiting, and
immediately changes to said torque control output current control value.

28. The electric power steering apparatus according to claim 22, wherein said current limiting section comprises:
a latch section to latch said torque control output current command value, said column input-side angle signal and said column output-side angle signal just before transiting from a steer-forward to said steering holding state;
a limiting judging section to input said column input-side angle signal, said column output-side angle signal, a latched column input-side angle signal, a latched column output-side angle signal and said steering holding signal, and output a judging signal;
a limiting section to input a latched torque control output current command value and said judging signal, and output a limiting current; and
a minimum value selecting section to input aid torque control output current command value and said limiting current, and output a minimum value as a limiting current value.

29. The electric power steering apparatus according to claim 23, wherein said current limiting section comprises:
a latch section to latch said torque control output current command value, said column input-side angle signal and said column output-side angle signal just before transiting from a steer-forward to said steering holding state;
a limiting judging section to input said column input-side angle signal, said column output-side angle signal, a latched column input-side angle signal, a latched column output-side angle signal and said steering holding signal, and output a judging signal;
a limiting section to input a latched torque control output current command value and said judging signal, and output a limiting current; and
a minimum value selecting section to input aid torque control output current command value and said limiting current, and output a minimum value as a limiting current value.

30. The electric power steering apparatus according to claim 24, wherein said current limiting section comprises:
a latch section to latch said torque control output current command value, said column input-side angle signal and said column output-side angle signal just before transiting from a steer-forward to said steering holding state;
a limiting judging section to input said column input-side angle signal, said column output-side angle signal, a latched column input-side angle signal, a latched column output-side angle signal and said steering holding signal, and output a judging signal;
a limiting section to input a latched torque control output current command value and said judging signal, and output a limiting current; and
a minimum value selecting section to input aid torque control output current command value and said limiting current, and output a minimum value as a limiting current value.

31. The electric power steering apparatus according to claim 26, wherein said current limiting section comprises:
a latch section to latch said torque control output current command value, said column input-side angle signal and said column output-side angle signal just before transiting from a steer-forward to said steering holding state;
a limiting judging section to input said column input-side angle signal, said column output-side angle signal, a latched column input-side angle signal, a latched column output-side angle signal and said steering holding signal, and output a judging signal;
a limiting section to input a latched torque control output current command value and said judging signal, and output a limiting current; and
a minimum value selecting section to input aid torque control output current command value and said limiting current, and output a minimum value as a limiting current value.

32. The electric power steering apparatus according to claim 28, wherein when said steering holding signal is a steering holding state, a difference between said latched column input-side angle signal and said latched column output-side angle signal is a predetermined amount or less and a difference between said latched column output-side angle signal and said present column output-side angle signal is a predetermined amount or less, said limiting judging section judges that said current limiting is capable.

33. The electric power steering apparatus according to claim 29, wherein when said steering holding signal is a steering holding state, a difference between said latched column input-side angle signal and said latched column output-side angle signal is a predetermined amount or less and a difference between said latched column output-side angle signal and said present column output-side angle signal is a predetermined amount or less, said limiting judging section judges that said current limiting is capable.
